(19) United States
(12) Patent Application Publication
(10) Pub. No.: US 2025/0168635 A1
(43) Pub. Date: May 22, 2025

(54) AUTHENTICATION AND AUTHORIZATION FOR LOCALIZED SERVICES

(71) Applicant: Intel Corporation, Santa Clara, CA (US)

(72) Inventors: Alexandre Saso Stojanovski, Paris 75 (FR); Abhijeet Kolekar, Portland, OR (US)

(21) Appl. No.: 18/840,412

(22) PCT Filed: May 3, 2023
(86) PCT No.: PCT/US2023/066529

§ 371 Date: Aug. 21, 2024

Related U.S. Application Data
(60) Provisional application No. 63/339,238, filed on May 6, 2022.
(60) Provisional application No. 63/353,412, filed on Jun. 17, 2022.

(51) Int. Cl. H04W 12/06; H04W 12/0433; H04W 12/61

(52) U.S. Cl. CPC H04W 12/06; H04W 12/0433; H04W 12/61

(57) ABSTRACT

The present disclosure provides technologies and techniques related to enabling access to localized services. The present disclosure provides mechanisms for authentication and authorization for enabling a non-public network (NPN) to act as a hosting network for providing access to localized services. Additionally, the present disclosure provides mechanisms for enabling user equipment (UE) to discover, select and access an NPN acting as a hosting network to receive localized services. Furthermore, the present disclosure provides mechanisms for enabling access to localized services via a specific hosting network.

### RELATED APPLICATIONS

The present application claims priority to U.S. Provisional App. No. 63/339,238 filed May 6, 2022, and U.S. Provisional App. No. 63/353,412 filed Jun. 17, 2022, the contents of each of which are hereby incorporated by reference in their entireties.

### FIELD

The present disclosure is generally related to wireless communications technologies, network topologies, network and information security technologies, and in particular, to technologies and techniques related to accessing localized services.

### BACKGROUND

As part of the third generation partnership project (3GPP) release-18 (Rel-18) enhanced non-public network (eNPN) study, access to localized services is studied. Providing local services refers to providing access to a hosting network and a set of services offered by the hosting network provider and 3rd party service providers, including other network operators and 3rd party application providers. The services may be localized (e.g., provided at a specific and/or limited area and bound in time). The user may become aware of the available access to local services and the process to gain and terminate access to the hosting network and local services. This process should be efficient and convenient from a user experience standpoint.

A fifth generation (5G) network can act as a hosting network offering access to localized services either as a public network integrated non-public network (PNI-NPN) or a stand-alone non-public network (SNPN). Different entities can operate the hosting network and the localized services. Localized services may provide more than just data connectivity to end-users, for example, additional information/incentive/instructions to seek access to the localized services.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings in which:

FIG. 1 depicts an example solution for access to localized services based on AKMA;

FIG. 2 depicts an example procedure for access to localized service based on AKMA;

FIG. 3 depicts an example solution for access to localized services based on digital certificate;

FIG. 4 depicts an example procedure for access to localized service based on digital certificate;

FIG. 5 depicts an example procedure for providing access to local service;

FIG. 6 depicts an example over-the-top (OTT) solution for access to localized services;

FIG. 7 depicts an example OTT-related procedure for access to localized service;

FIGS. 8a, 8b, 9 depict example wireless networks;

FIG. 10 depicts example hardware resources; and

FIGS. 11, 12, and 13 depict example processes for practicing the various embodiments discussed herein.

### DETAILED DESCRIPTION

### 1. Localized Service Aspects

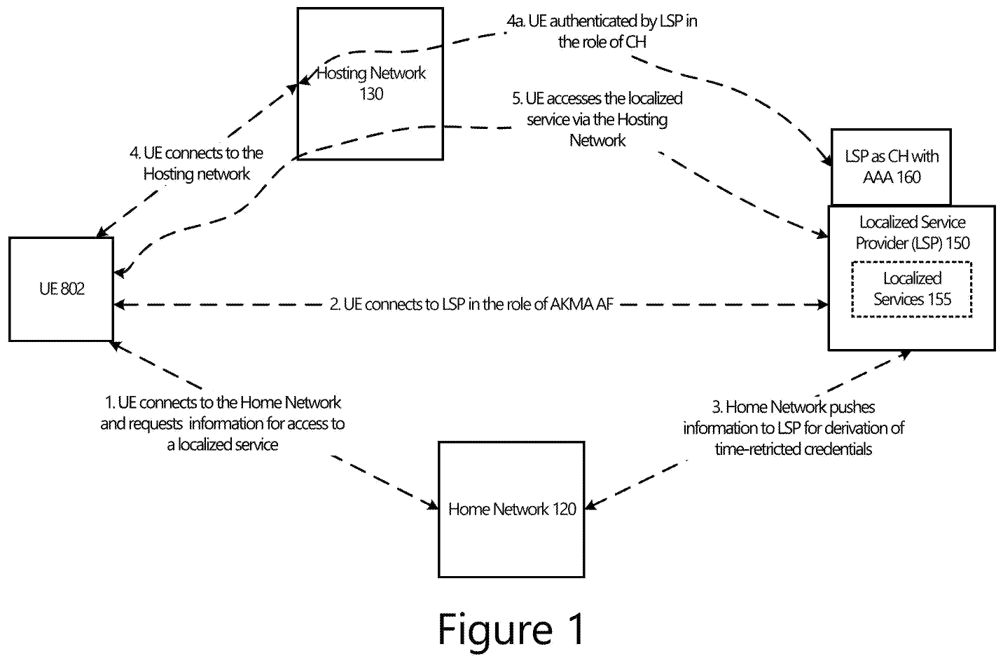

A localized service is a service that is provided at specific/limited area and/or can be bounded in time. The service can be realized via applications (e.g., live or on-demand audio/video stream, electric game, IMS, and/or the like), or connectivity (e.g., UE to UE, UE to Data Network, and/or the like). A localized service provider (LSP) (e.g., LSP 150 in FIG. 1) is an application provider or network operator who makes their services localized and that are offered to an end user (e.g., UE 802) via a hosting network (e.g., hosting network 130 in FIG. 1). A hosting network 130 can be a non-public network (NPN), such as a standalone NPN (SNPN) or a public network integrated (PNI)-NPN. Support for NPNs is described by clause 5.30 of [TS23501].

### 1.1. Authentication and Authorization for Localized Services

3GPP TR 23.700-08 (“[TS23700-08]”) discusses issues relevant to the authentication and authorization aspects of enabling NPN as a hosting network 130 for providing access to localized services 155 (see e.g., clause 5.3 in [TS23700-08]), enabling UE to discover, select and access NPN as hosting network 130 and receive localized services 155 (see e.g., clause 5.4 in [TS23700-08]), and enabling access to localized services 155 via a specific hosting network 130 (see e.g., clause 5.5 in [TS23700-08]).

[TS23700-08] is studying the capability to provide access to a hosting network 130 and a set of services offered by the hosting network provider and 3rd party service providers, including other network operators and 3rd party application providers. Access to local services 155 by enabling NPN as a hosting NPN or hosting network 130 is being studied, including architectural enhancements for the discovery, selection, and accessing of NPN as a hosting network 130 and receiving localized services 155, service availability of a hosting network 130, seamless service continuity for home network services and localized services 155, UE identification, configuration for such services, network selection, authentication, and authorization procedure for UE 802 and localized services 155.

Unauthorized access by UEs 802 to the hosting network 130 may cause the resources of the hosting network 130 to be misused or overloaded. Weak authentication procedures may allow attackers/hackers to impersonate the UE 802 towards the hosting network 130 or vice versa, and thereby gain unauthorized access to the hosting network 130 resulting in data breaches.

For access to localized services 155, the UE 802 needs to be authorized and authenticated to such services. The manner in which UEs 802 can be authenticated with the hosting network 130 and avail localized services 155 is currently being studied. The present disclosure considers procedures for acquiring credentials to access localized services 155.

The UE 802 should be authorized to access localized services 155. In various implementations, the UE 802 and the hosting network 130 mutually authenticate before granting access to localized services 155. The 5GS supports a procedure allowing a UE 802 to access a hosting network 130 to avail of localized services 155 securely.

### 1.1.1. Option 1: Access to Localized Services Based on AKMA

The present disclosure addresses authentication and authorization aspects of enabling NPN as a hosting network 130 for providing access to localized services 155 to a UE 802.

FIG. 1 depicts an example of authentication between a UE 802 and a hosting network 130 for access to localized services 155 using Authentication and Key Management for Applications (AKMA) as defined in [TS35535]. The solution uses AKMA Anchor Key (K_{AKMA}) derived from the AKMA procedures after the primary authentication with UE 802 and the home network 120 as the trusted root to perform the authentication between the UE 802 and the hosting network 130. The K_{AKMA} generates or otherwise includes time-restricted credentials for authentication with the hosting network 130.

When the UE 802 arrives at the venue where the localized service is provided (e.g., stadium), the user manually selects the hosting network 130. UE 802 connects to the hosting network 130 and is authenticated by the LSP 150 in the role of credential holder (CH) 160 (e.g., using an authentication, authorization, and accounting (AAA) server) based on the user ID and security credential for access to the home network 120. The UE 802 requests a PDU Session to the provided DNN/S-NSSAI and accesses the localized service of the LSP 150 via the hosting network 130 based on the user ID and security credential for access to the LSP 150 server providing the localized service 155.

The home network 120 pushes time-restricted credentials (e.g., one-time credentials and/or the like) to the LSP 150 providing this service. The time-restricted credentials include, e.g., the following: SNPN ID and geographical coordinates of the hosting network 130; user id and security credential for access to the home network 120; user id and security credential based on AKMA for access to the LSP 150 server providing the localized service; and DNN/S-NSSAI for establishing a PDU Session in the hosting network 130 with optional AKMA-based credentials for secondary authentication.

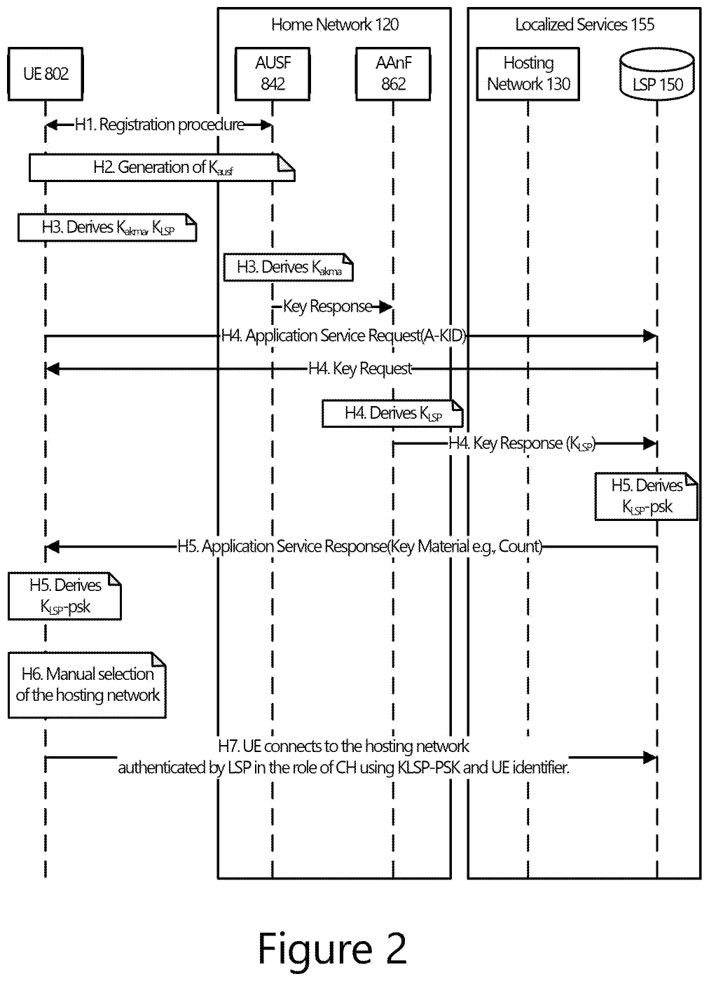

FIG. 2 shows an example procedure for access to localized services 155 based on AKMA. The procedure of FIG. 2 may operate as follows:
H1. The LSP 150 establishes a service agreement with the operator of a hosting network 130. The LSP 150 also establishes a service agreement with UE's 802 home network 120 operator to enable the UE 802 to receive the information needed to discover/access hosting network 130 and the localized service 155.
H2. The hosting network 130 is configured based on the service agreement, e.g., DNN/S-NSSAI configuration for access to localized service 155, quality of service (QoS), number of end-users, time, location, whether home network services can be accessed via the hosting network 130, and/or the like. The configuration of the hosting network 130 is performed. The UE 802 performs the procedures defined in [TS23502] to get the 5GC network access. At the end of the network access authentication procedure (primary authentication and key agreement in 3GPP TS 33.501, clause 6.1)), the UE 802 and the AUSF are in possession of the key K_{AUSF}.
H3. The UE 802 and the AUSF derive the AKMA key (e.g., K_{AKMA}) as specified in [TS35535]. The AUSF 842 provides the AKMA key (e.g., K_{AKMA}) to the AKMA Anchor Function (AAnF) 862 as specified in [TS35535].
H4. UE's 802 user is prompted by localized service advertisements. The UE 802 initiates the Application Request Service procedure with the LSP 150 and includes AKMA Key ID (A-KID) in an Application Service request message. LSP 150 acts as an Application Function (AF) for the AAnF 862 as specified in [TS35535]. The LSP 150 contacts the AAnF 862 (e.g., using AKMA key ID/A-KID) to obtain the corresponding key K_{LSP} (K_{AF}) of the UE 802 if it does not hold a valid K_{LSP} of the UE 802 or the AKMA Key ID provided by the UE 802 is different from the previous AKMA Key ID. The AAnF 862 provides the derived key (K_{AF}) to the LSP 150. The K_{LSP} is the AKMA Application Key (K_{AF}) and is derived as specified in [TS35535] by both the UE 802 and the LSP 150.
H5. The LSP 150 uses the key K_{LSP} to derive the key K_{LSP}-PSK. The K_{LSP}-PSK is derived and used as the pre-shared key (PSK) to establish transport layer security (TLS) between the UE 802 and the LSP 150. Once the K_{LSP}-PSK is derived, the LSP 150 includes the CounterLSP used to derive the K_{LSP}-PSK to the UE 802 in an Application Service response message. On receiving the application service response message, the UE 802 derives K_{LSP}-PSK, derived by the AUSF using the received CounterLSP value. K_{LSP}-PSK acts as time-restricted credentials as per [TS35535] AKMA key lifetime procedures.
H6. When the UE 802 arrives at the venue where the localized service 155 is provided (e.g., stadium), the user manually selects the hosting network 130.
H7. UE 802 connects to the hosting network 130 and is authenticated by the LSP 150 in the role of Credential Holder (e.g., using a AAA server) using credentials obtained in step H5. For example, the UE 802 establishes an extensible authentication protocol (EAP)-TLS session with the LSP 150 to authenticate with hosting network 130. Mutual authentication is performed between the UE 802 and the LSP 150 using TLS, based on pre-shared keys (PSKs) (e.g., K_{LSP}-PSK) following TLS 1.2 (see e.g., Eronen et al., Pre-shared Key Ciphersuites for Transport Layer Security (TLS), INTERNET ENGINEERING TASK FORCE (IETF), Request for Comments (RFC) 4279 (December 2005)) and/or TLS 1.3 (see e.g., Rescorla, The Transport Layer Security (TLS) Protocol Version 1.3, IETF RFC 8446 (August 2018) and/or Housley et al., Guidance for External Pre-Shared Key (PSK) Usage in TLS, IETF RFC 9257 (July 2022)).
H8. UE 802 requests a PDU Session and accesses the localized service 155 of the LSP 150 via the hosting network 130. In parallel, the UE 802 can access the services of the home network 120 using an OTT (e.g., Nwu interface) connection to an N3IWF node 865 in the home network 120.
H9. Upon expiry of the time-restricted credentials, the LSP 150 in the role of Credential Holder requests a release of the UE 802 as per [TS35535] AKMA.
H10. When the localized service agreement is terminated, the hosting network 130 removes the configured information (configured in step H2).

### 1.1.2. Option 2: Access to Localized Services Based on Digital Certificate

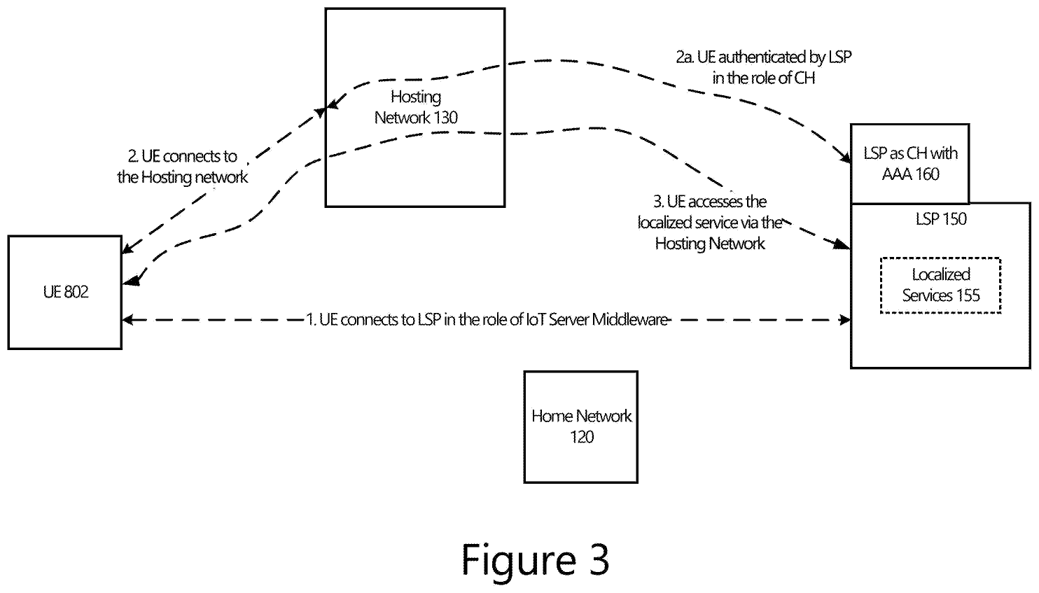

FIG. 3 shows an example solution for access to localized services 155 based on digital certificate. For the solution illustrated by FIG. 3, the UE 802 contains a subscriber identity module (SIM) or universal integrated circuit card (UICC) with LSP security applet. The SIM with the LSP security applet plays the role of a SIM with IoT security applet defined in clause 3 of Common Implementation Guide to Using the SIM as a ‘Root of Trust’ to Secure IoT Applications, GSMA™, Official Document IoT.04, version 1.0 (3 Dec. 2019) (“[GSMAIoT.04]”). Additionally, the LSP 150 contains LSP server middleware. The LSP server middleware plays the role of IoT Server Middleware described in clause 3 of [GSMAIoT.04].

In FIG. 3, at step 1, the UE 802 connects to the LSP 150 in the role of IoT server middleware. At step 2, the UE 802 connects to the hosting network 130, and at step 2a, the UE 802 is authenticated by the LSP 150 in the role of CH 160. At step 3, the UE 802 accesses the localized service 155 via the hosting network 130.

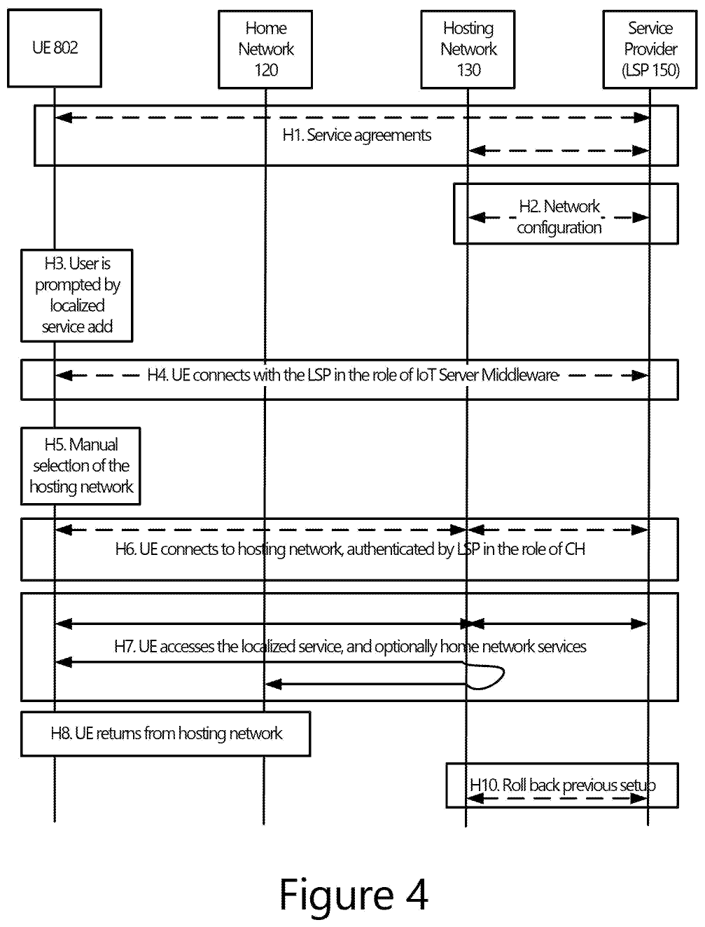

FIG. 4 shows an example procedure for access to localized services 155 based on digital certificate. The procedure of FIG. 4 may operate as follows:
H1. The LSP 150 establishes a service agreement with the operator of a hosting network 130. The LSP 150 also establishes a service agreement with the UE 802 to enable the UE 802 to receive the information needed to discover/access hosting network 130 and the localized service 155.
H2. The hosting network 130 is configured based on the service agreement (e.g., DNN/S-NSSAI configuration for access to localized service, QoS, number of end-users, time, location, whether home network services can be accessed via the hosting network 130, and/or the like). The configuration of the hosting network 130 is performed. The UE 802 performs the procedures defined in [TS23502] to get the 5GC network access.
H3. Localized service advertisements prompt UE's 802 users.
H4. UE's 802 user connects to the LSP 150 acting in the role of IoT server middleware described in clause 3 of [GSMAIoT.04]. The connection can be established via UE's 802 home network 120 or via any other type of network or Internet access. The UE 802 sends a service provisioning request to the LSP 150 to trigger client certificate provisioning. The requested client certificate will be used to perform mutual authentication between the UE 802 and the hosting network 130 through the LSP 150. The LSP 150 sends to the UE's 802 SIM applet certificate and Security Profile corresponding to the LSP 150. The Security Profile associated with the SIM contains all necessary data to establish a TLS tunnel between the LSP 150 and UE 802. The LSP Security Service checks whether LSP-related data have already been downloaded to SIM with LSP Security Applet, checks the client certificate validity, and determines whether LSP-related data have to be downloaded to the SIM with LSM Security Applet. The LSM Security Service responds to the LSP 150, indicating whether LSP-related data must be downloaded to the SIM. The SIM with LSM Security Applet sends “Open channel” command. The KSMO Security Service downloads to the SIM with an LSM Security Applet client certificate, enabling to establish TLS tunnel between UE 802 and the LSP 150, and optionally LSP certificate or root certificate.
   The LSP 150 sends a Security Profile corresponding to the UE 802 and LSP certificate to the LSP Security Service. The Security Profile associated with the SIM contains all necessary data to establish a TLS tunnel between the LSP 150 and UE 802.
   The LSP Security Service checks whether LSP-related data have already been downloaded to the SIM with Edge Security Applet, checks the client certificate validity, and determines whether LSP-related data have to be downloaded to the SIM with Edge Security Applet.
H5. When the UE 802 arrives at the venue where the localized service is provided (e.g., stadium), the user performs a manual selection of the hosting network 130.
H6. UE 802 connects to the hosting network 130 and is authenticated by the LSP 150 in the role of Credential Holder (e.g., using a AAA server) using credentials downloaded in H4.
H7. UE 802 requests a PDU Session and accesses the localized service of the LSP 150 via the hosting network 130. In parallel, the UE 802 can access the services of the home network 120 using an OTT (e.g., Nwu reference point) connection to an N3IWF node 865 in the home network 120.
H8. Upon expiry of the time-restricted credentials, the LSP 150 in the role of Credential Holder requests a release of the UE 802.
H10. When the localized service agreement is terminated, the hosting network 130 removes the configured information (configured in step H2).

### 1.2. Over-The-Top (OTT) Solutions for Access to Localized Services

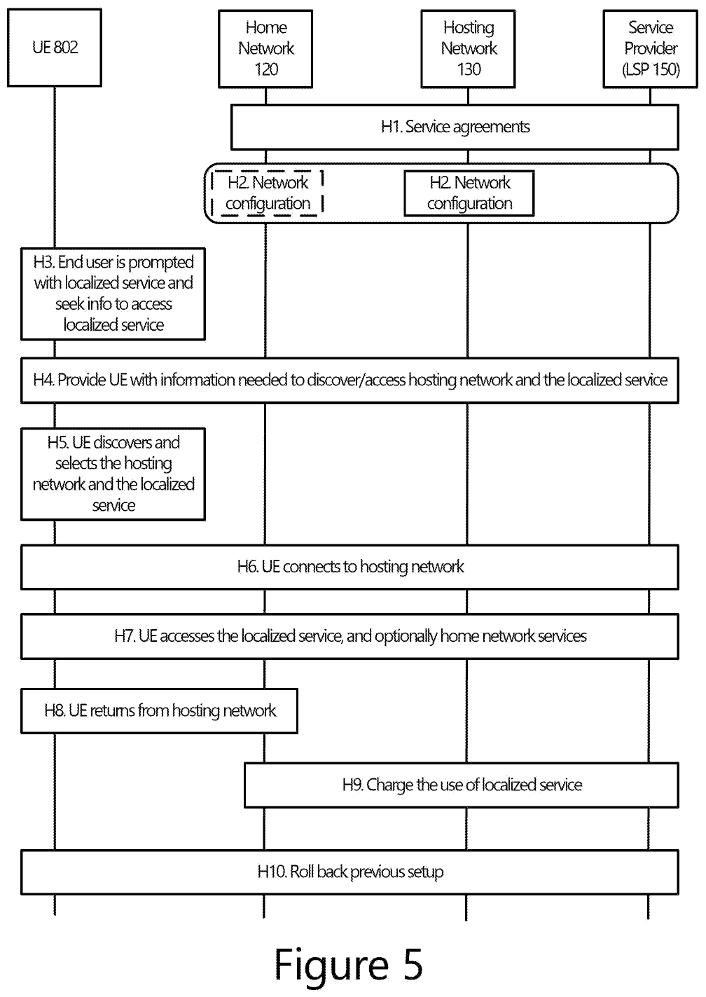

FIG. 5 shows an example procedure to enable localized service. The hosting non-public network (NPN) 130 may provide access to localized services 155. But home network operator of a UE 802 can also utilize the hosting network 130 based on a relationship established between the hosting network operator and UE's 802 home operator so that it is possible to enable the UE 802 with a subscription from home network to access home network services via the hosting network 130, in addition to the localized services 155. The home network steers its UE(s) 802 to a hosting network 130 considering the location, times, coverage of the hosting network 130, and services offered by the home network and hosting network 130. A localized service agreement is established. The home network operator indicates to the UE 802 what services are preferred to be used from the home network when the UE 802 connects to a hosting network 130 and the requested services are available from both the hosting and the home network. Based on localized service agreements, the hosting network 130 provides required connectivity and QoS for a UE 802 simultaneously connected to the hosting network 130 for localized services 155 and its home network for home network services. A UE 802 connects to its home network via the hosting network 130 if supported by the hosting network 130 and the home network based on localized service agreements.

The OTT solutions discussed herein addresses issues related to enabling UEs 802 to discover, select and access NPN as hosting network 130 and receive localized services 155 (see e.g., clause 5.4 in [TS23700-08]) and issues related to enabling access to localized services 155 via a specific hosting network 130 (see e.g., clause 5.5 in [TS23700-08]). In various implementations, the UE 802 (user) obtains the time-restricted credentials from the LSP via the home network and uses that information for selection of hosting network as well as to access localized services. N3IWF node used to access home network services.

The solution has no specification impact from SA WG2 perspective unless being identified by SA WG3

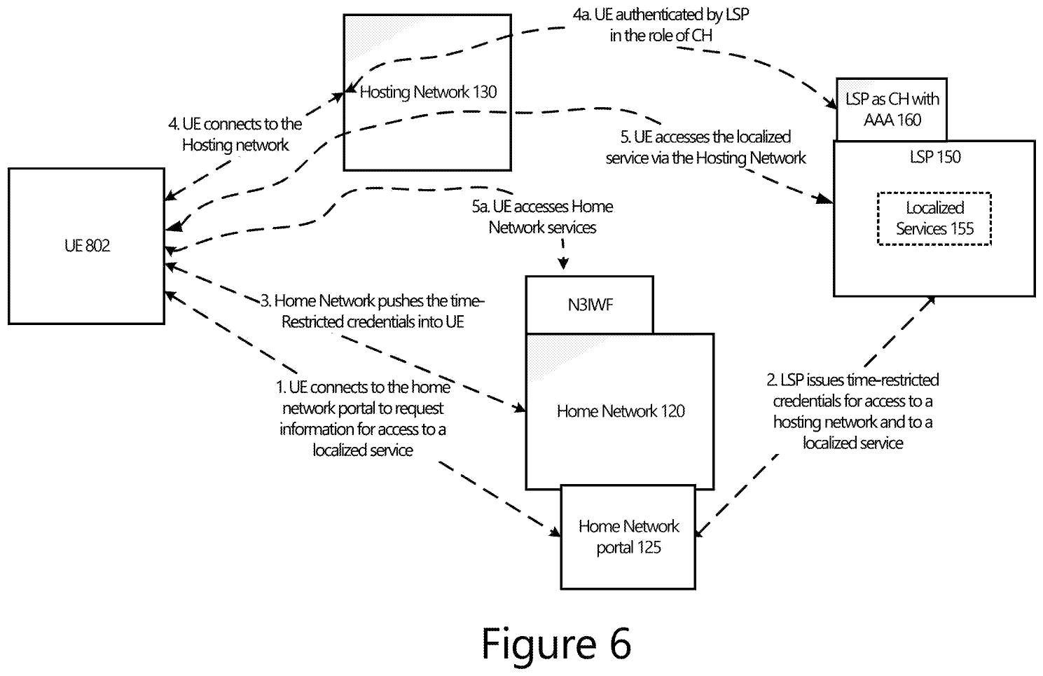

FIG. 6 illustrates an example relationship between LSP 150, the hosting network 130, and UE's 802 home network 120. The relationships shown by FIG. 6 include the following aspects or features.

The LSP 150 has a service agreement with UE's 802 home network 120 and a hosting network 130. There is no direct agreement between UE's 802 home network 120 and the hosting network 130.

At step 1, the UE's 802 user connects to a web portal 125 of the home network operator to request information for access to a localized service 155.

At step 2, the LSP 150 issues time-restricted credentials for access to a hosting network 130 and to a localized service 155. The home network 120 obtains time-restricted credentials from the LSP 150 providing the localized service 155. Examples of the time-restricted credentials include one or more of the following: SNPN ID and geographical coordinates of the hosting network 130; user id and security credential for access to the home network 120; user id and security credential for access to the LSP 150 server providing the localized service 155; and data network name (DNN)/single network slice selection assistance information (S-NSSAI) for establishing a PDU Session in the hosting network 130 with optional credentials for secondary authentication; time-based one-time passwords (TOTPs); and/or out-of-band (OOB) one-time passwords (OTPs). The specific type of time-restricted credentials that are used may be implementation-specific.

At step 3, the home network 120 pushes the time-restricted credentials into the UE 802 (e.g., using short message service (SMS) messaging, TOTPs, OOB OTPs, third party authenticator application, and/or the like). When the UE 802 arrives at the venue where the localized service is provided (e.g., stadium), the user performs a manual selection of the hosting network 130. UE 802 connects to the hosting network 130 and is authenticated by the LSP 150 in the role of CH 160 (e.g., using a AAA server) based on the user id and security credential for access to the home network 120.

At step 4, the UE 802 connects to the hosting network 130, and at step 4a, the UE 802 is authenticated by the LSP in the role of CH 155. At step 5, the UE 802 accesses the localized service 155 via the hosting network 130. Here, the UE 802 requests a PDU Session to the provided DNN/S-NSSAI and accesses the localized service of the LSP 150 via the hosting network 130 based on the user id and security (time-restricted) credential for access to the LSP server 150 providing the localized service 155. In parallel, at step 5a, the UE 802 can access the services of the home network 120 using an OTT (NWu) connection to an N3IWF node 865 in the home network 120.

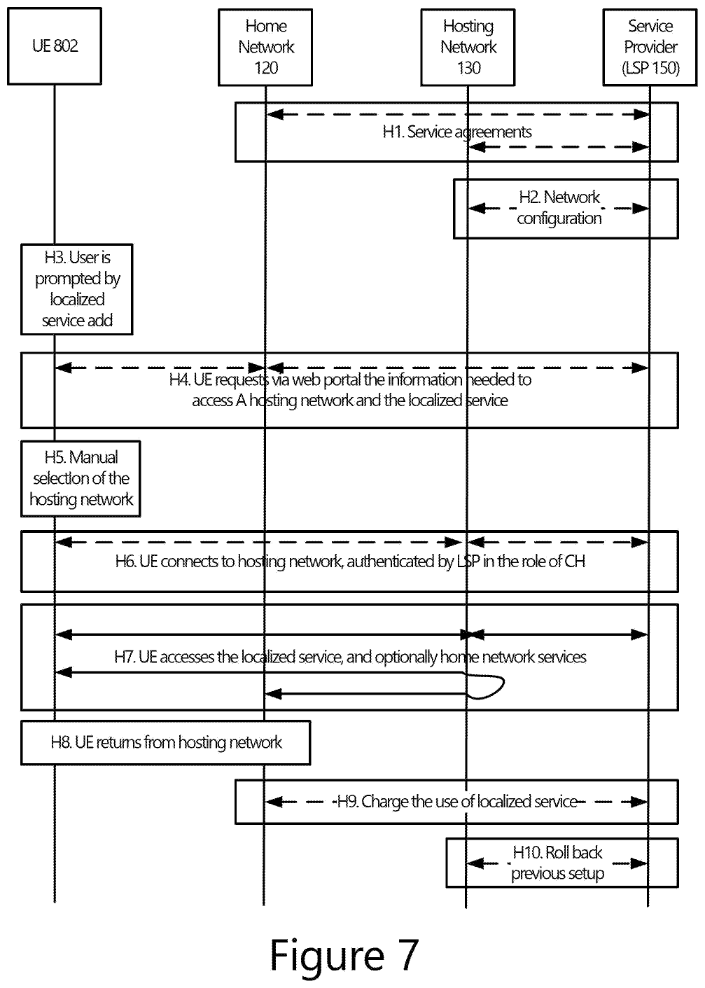

FIG. 7 shows an example procedure for access to localized services, which may operate as follows:
H1. The LSP 150 establishes a service agreement with the hosting network 130 operator. The LSP 150 also establishes a service agreement with UE's 802 home network operator to enable the UE 802 to receive the information needed to discover/access hosting network 130 and the localized service.
H2. The hosting network 130 is configured based on the service agreement, e.g., DNN/S-NSSAI configuration for access to localized service, QoS, number of end-users, time, location, whether home network services can be accessed via the hosting network 130, and/or the like. The configuration of the hosting network 130 is performed by means that are outside of the 3GPP scope.
H3. Localized service advertisements prompt UE's 802 users and/or the UE's 802 user is prompted by localized service advertisement.
H4. UE's 802 user connects to a web portal of the home network operator to request information for access to a localized service. The home network 120 obtains time-restricted credentials from the LSP 150 providing this service. The time-restricted credentials are described in previously. The home network 120 pushes the time-restricted credentials into the UE 802 (e.g., using SMS, via the web portal, third party authenticator application, and/or the like). The solution assumes that the LSP has service agreement with the home network 120 (see e.g., FIG. 5). If the UE 802 has a direct service relationship with the LSP 150, the home network 120 can be circumvented.
H5. When the UE 802 arrives at the venue where the localized service is provided (e.g., stadium, enterprise/organization campus, and/or the like), the user/UE 802 manually selects the hosting network 130.
H6. UE 802 connects to the hosting network 130 and is authenticated by the LSP 150 in the role of CH 160 (e.g., using an AAA server).
H7. UE 802 requests a PDU Session and accesses the localized service of the LSP 150 via the hosting network 130. In parallel, the UE 802 can access the services of the home network 120 using an OTT (NWu) connection to an N3IWF node in the home network 120.
H8. Upon expiry of the time-restricted credentials, the LSP 150 in the role of Credential Holder requests a release of the UE 802.
H9. LSP 150 collects and provides charging information to UEs' 802 home network 120 operators outside of 3GPP specifications.
H10. When the localized service agreement is terminated, the hosting network 130 removes the configured information (configured in step H2) by means that are outside of the 3GPP scope.

### 1.3. Access to Localized Services

In addition to the embodiments discussed previously, the various embodiments discussed herein can include the following aspects.

### 1.3.1. Providing Access to Local Services

Providing access to local services 155 refers to the capability to provide access to a hosting network 130 and a set of services offered by the hosting network provider, and 3rd party service providers including other network operators and 3rd party application providers. The services 155 can be localized (e.g., provided at specific/limited area) and can be bounded in time. The user can become aware of the available access to local services 155, and the process to gain and terminate access to the hosting network 130 and local services 155. This process should be efficient, and convenient from a user experience standpoint.

Providing access to local services 155 creates new opportunities for users and service providers. For example, access can be provided in areas where there is no coverage provided by other networks (e.g., on a fairground established far from other infrastructure), or the access and local services can be established as needed (e.g., on a short-term basis), without the need for long term business relationships, permanently installed equipment, and/or the like.

The type of local services 155 and access for localized services 155 via a hosting network 130 can be promoted and arranged through different channels. Principally the service providers 150 (e.g., brick and mortar businesses, entertainment venues, construction contractors, first responder agencies, enterprises, and/or the like) will provide information and proper incentive or instructions to potential users so that they will seek to access the localized services 155 via hosting networks 130.

Both the home network 120 and the hosting network 130 can be a PLMN or NPN. In some examples, only subscribers of a public network can roam into a PLMN. Examples of interworking scenarios between network operators and application providers for localized services are indicated in Annex H of [TS22261].

### 1.3.1.1. Configuration of Localized Services in Hosting Network

The 5G system (5GS) supports suitable mechanisms to allow automatically establishing localized service agreements for a specific occasion (e.g., time and location) and building temporary relationship among hosting network operator and other service providers including network operators or 3rd party application providers. The term “service provider of localized services” also includes 3rd party service providers.

The 5GS supports means for the service provider to request the hosting network 130 via standard mechanisms to provide access to 3rd party services at a specific period of time and location. This period of time is flexible, so that a change in service provision can be decided at any time (e.g., to cancel or prolong local services in the locality of service delivery) based on localized services agreements.

Based on localized services agreements, the 5GS provides suitable means to allow the service provider to request and provision various localized service requirements, including QoS, expected/maximum number of users, event information for discovery, network slicing, required IP connectivity and/or the like, and routing policies for the application of the localized services 155 via the hosting network 130.

The 5GS supports means for a hosting network 130 to create policies and configure resources for the requested time and location for the 3rd party services based on the received request.

The 5GS supports means for a hosting network 130 to notify the service provider of the accepted service parameters and routing policies.

Subject to regulatory requirements and localized service agreements, the 5GS allows a home network operator to automatically negotiate policies with the hosting network 130 for allowing the home network's 120 subscribers to connect at a specific occasion (e.g., time and location) for their home network services.

Subject to the automatic localized services agreements between the hosting network operator and home network operator, for a UE 802 with only home network subscription and with authorization to access hosting networks 130 the 5GS supports access to the hosting network 130 and use home network services or selected localized services 155 via the hosting network 130, seamless service continuity for home network services or selected localized services 155 when moving between two hosting networks or a host network and the home network.

The 5GS supports a mechanism to enable configuration of a network that provides access to localized services 155 such that the services can be limited in terms of their spatial extent (in terms of a particular topology, for example, a single cell), as specified by a service provider of localized services 155.

The 5GS supports a mechanism to enable configuration of a network that provides access to localized services 155 such that the services can be limited in terms of the resources or capacity available, to correspond to requirements that apply only to the locality of service delivery, as specified by a service provider of localized services 155.

The 5GS supports means for a hosting network 130 to provide a 3rd party service provider with information for automatic discovery of the hosting network 130 by the UEs 802 to allow access to specific 3rd party services.

The 5GS supports secure mechanisms to allow a home network 120 to coordinate with a hosting network 130 for a subscriber to temporarily access the hosting network 130 (e.g., based on temporary credentials) at a given time (start time and duration) and location.

### 1.3.1.2. User Manual Selection of Localized Services via Hosting Network

The hosting network 130 allows a UE 802 to manually select temporary localized services 155 which are provided via local breakout at the hosting network 130.

NOTE: localized services 155 which are provided via local breakout at the hosting network 130 can be based on interworking scenarios for hosting network 130 owned/collaborative services as indicated in Annex H.

### 1.3.1.3. UE Configuration, Provisioning, Authentication and Authorization

Subject to localized services agreements, the 5GS enables a home network operator to authorize a UE 802 for using its home network services via a hosting network 130 for a certain period of time and/or location.

The 5GS allows a trusted 3rd party service provider to provide UEs 802 with localized service policy (e.g., QoS, network slice in the hosting network 130 or home network 120, service restriction such as time and location) via the hosting network 130 or the UE's 802 home network 120.

The 5GS enables a UE 802 to use credentials provided by the hosting network 130 with or without coordination with the home network 120 of the UE 802, to make use of localized services 155 via the hosting network 130 with a certain time (including starting time and the duration) and location validity.

The 5GS is able to allow the home network 120 to steer its UE(s) 802 to a hosting network 130 with the consideration of the location, times, coverage of the hosting network 130 and services offered by the home network 120 and hosting network 130.

The 5GS provides support to enable secure means to authenticate and authorize a user of a UE 802 accessing a hosting network 130, including cases in which a UE 802 has no subscription to the hosting network 130 and still needs to get authorized to use localized services 155 via the hosting network 130. It can be assumed that a network provider deploying a hosting network 130 has access to respective identification information about the user (e.g., through a separate registration process).

The 5GS is able to authenticate and authorize the UE 802 of a user authenticated to a hosting network 130 to access the hosting network 130 and its localized services 155 on request of a service provider.

### 1.3.1.4. UE Discovery, Selection and Access

Subject to operator's policy and agreement between a 3rd party service provider and operator, the 5GS shall enable a UE 802 to receive and use configuration provided by a 3rd party service provider to discover and access a hosting network 130 and localized services 155, including the considerations of prior service agreement with a 3rd party service provider and no prior subscription to hosting network 130. If the UE 802 is able to obtain services from two networks simultaneously, it may additionally select the hosting network 130. If the UE 802 cannot maintain the connection to the home network 120 while selecting the hosting network 130, the selection shall only be done on request by the user, e.g., using manual selection.

The 5GS supports secure means for a UE 802 to select and access localized services 155 which may be provided by a 3rd party service provider via a hosting network 130, independent of prior subscription to the hosting network 130 or 3rd party service provider.

The 5GS shall enable the home network 120 to allow a UE 802 to automatically select a hosting network 130 for accessing localized services 155 when specified conditions (e.g., predefined time, location) are fulfilled.

The 5GS shall be able to prevent a UE 802 to re-access the hosting network 130 after the localized services 155 were terminated if the authorization for the localized services 155 is no longer valid (e.g., can be based on certain conditions such as time or location of the user).

The 5GS may support means for a UE 802 which may or may not have prior subscription to the hosting network 130 to display human readable information on how to gain access to the hosting network 130 and available 3rd party services.

The 5GS supports a mechanism to allow a user to manually select a specific local hosting network 130. Additional information can be presented to the user to facilitate the manual network selection.

The 5GS is able to limit access of specific UEs 802 to a configurable area of a hosting network 130′s coverage area.

The 5GS is able to maintain privacy of a user against the hosting network 130 while the UE 802 does not make use of the hosting network 130, for example, to prevent tracking of UEs 802 by hosting networks 130.

The 5GS shall enable the home network 120 to instruct a UE 802 to select a hosting network 130 with certain conditions (e.g., predefined time, location) based on the request from a service provider.

The 5GS shall enable the home network 120 to allow a UE 802 to select a hosting networks 130 or change to another hosting networks 130, without any additional user intervention as long as the delivered services, both localized services 155 and home routed services, are unchanged.

### 1.3.1.5. Hosting Network Localized Services and Home Operator Services

The 5GS shall enable the home network operator to indicate to the UE 802 what services are preferred to be used from the home network 120 when the UE 802 connects to a hosting networks 130 and the requested services are available from both the hosting and the home network 120.

Based on localized service agreements, the hosting networks 130 shall be able to provide required connectivity and QoS for a UE 802 simultaneously connected to the hosting networks 130 for localized services and its home network 120 for home network services.

A UE 802 is able to connect to its home network 120 via the hosting networks 130, if supported by the hosting networks 130 and the home network 120 based on localized service agreements.

### 1.3.1.6. Returning to Home Network

The 5GS provides mechanisms to mitigate user plane and control plane overload caused by a high number of UEs 802 returning from a temporary local access of a hosting networks 130 to their home network 120 in a very short period of time.

The 5GS provides mechanisms to minimize the impact on the UEs 802 communication e.g., to prevent user plane and control plane outages when returning to a home network 120 together with other high number of UEs 802 in a very short period of time, after terminating their temporary local access to a hosting networks 130.

### 1.1.1. Enabling Access to Localized Services

To enable a PNI-NPN or SNPN to provide access to localized services 155, the PNI-NPN or SNPN operator configures the network with information enabling the UEs 802 to access the localized services 155 using the PNI-NPN or SNPN according to any validity of the localized services 155, and the information is determined in agreement with the LSP 150 (e.g., identification of each localized service (e.g., to be used in UE Route Selection Policy (URSP) rules); validity restriction for each localized service, e.g., the validity of time and/or location; service parameters for each localized service (e.g., DNN, S-NSSAI and QoS requirements); and/or service authorization methods (e.g., NSSAA or secondary authentication/authorization during PDU session establishment)).

To allow the UE 802 to access the PNI-NPN or SNPN using the HPLMN or subscribed SNPN credential, the PNI-NPN or SNPN can be configured, based on localized service agreements between the PNI-NPN or SNPN and the HPLMN or subscribed SNPN, to allow primary authentication towards a HPLMN, when a PNI-NPN or SNPN is providing access to the localized services 155, and to allow primary authentication towards a subscribed SNPN, when an SNPN is providing access to the localized services 155.

To allow the UE 802 to access the SNPN providing access to localized services 155 when new credential is required, the SNPN can provide UE onboarding function as specified in clause 5.30.2.10 of [TS23501] for the UE 802 to obtain credential and necessary information to access the SNPN, or the UE 802 can leverage existing credential and network connection to get access to a PVS via User Plane to obtain new credential.

To allow the UE 802 to access the PNI-NPN providing access to the localized services 155 where NSSAA or secondary authentication/authorization during PDU session establishment is required, the UE 802 can obtain new credential using remote provisioning functionality as defined in clause 5.39 of [TS23501].

To allow the UE 802 to access the HPLMN or subscribed SNPN services while being registered in the PNI-NPN or SNPN, the PNI-NPN or SNPN can establish service agreements and configure inter-connect with the HPLMN or subscribed SNPN operator. If a PNI-NPN is providing access to the localized services 155, the existing roaming architecture with home-routed PDU Sessions are used. If an SNPN is providing access to the localized services 155, then the UE 802 can access HPLMN or subscribed SNPN as described in Annex D, clauses D.3, D.6 and D.7 of [TS23501].

Additionally or alternatively, the UE 802 can obtain the localized service information from application server(s) 838, serving network 150, 155, home network 120, or hosting network 130.

In some examples, the UE 802 fetches the information from an application server 838 when a full set of new subscription/credential is provided to UE 802 via the application server 838. This example has less system impact on 5GS than other solutions. However, the home network subscription/credential is utilized for the UE 802 to establish PDU connection with the application server and the UE 802 needs to handle co-existence of multiple subscriptions/credentials on device. Additionally or alternatively, the UE 802 fetches the information from an application server 838 when the information includes a list of hosting networks 130 and an indication that home network 120 credential is to be used, there will be impact on network selection. The application server 838 obtaining such information via network exposure is not necessary, since it is covered as part of the SLA between localized service provider and hosting network operator.

For configuring the PNI-NPN or SNPN (e.g., creation of network slice/DNN for carrying localized service traffic), existing OAM mechanisms can be re-used as per clause 6.3.1 of 3GPP TS 28.557 that provides a solution for NPN provisioning by a network slice of a PLMN and for exposure of management capability of PNI-NPN. The attributes to support this management is further documented in 3GPP TS 28.541.

For session management level information and interactions such as monitoring the PNI-NPN or SNPN performance, and enabling suitable QoS for UE 802 in the PNI-NPN or SNPN for localized service, the following non-exhaustive options can be used: covered by the service level agreement (SLA) between the PNI-NPN or SNPN operator and the LSP 150; reuse the existing network exposure procedures as specified in clause 4.15 of [TS23502], where the LSP 150 is taking the AF role and utilizing the exposure capability provided by the PNI-NPN or SNPN; enable NEF 852/PCF 856 in the PNI-NPN or SNPN providing access to the localized services 155 (via AF of the LSP 150) to receive and forward the validity conditions and QoS requirements of the localized services 155 to the AMF 844/SMF 846 by reusing the existing PCF 856 initiated AM/SM policy association procedures described in clause 4.16 of [TS23502].

The UE 802 selects an SNPN providing access for localized services 155 as described in clauses 5.30.2.4.2 and 5.30.2.4.3 of [TS23501], and in 3GPP TS 23.122 (“[TS23122]”).

The access to a localized service is made available in a specific area and/or a specific period of time. After the UE 802 has successfully registered to a PNI-NPN/SNPN providing access to the localized service, the UE 802 can be configured with URSP rules using existing principles (see e.g., clause 6.6.2.2 of [TS23503]).

The URSP rules can include an association between the UE application and the DNN/S-NSSAI which is meant for a particular localized service. The URSP rules can also include “Route Selection Validation Criteria” as described in Table 6.6.2.1-3 of [TS23503], with the time/location defined for the particular localized service.

The existing LADN feature described in clause 5.6.5 of [TS23501] can also be used for enabling the UE access to localized service which is defined by a LADN DNN. The S-NSSAI used for a localized service can be restricted to a specific area and time as described in clause 5.15 of [TS23501].

When localized services 155 in a network are completed, all UEs 802 that are registered with the network are expected to be transferred to other network or to other network resources (e.g., other cells) within the same network, potentially within a relatively short timeframe. The other network can be HPLMN, VPLMN, or another SNPN.

UE 802 can stop using the network resources for localized services 155 for numerous reasons, e.g., when one or more of the following conditions apply: localized services 155 in a network are completed; validity conditions of network selection information are no longer met; the user decides to stop using the localized services 155 before they are completed; and/or a policy decision is taken by the network, with the effect that the UE 802 is deregistered before the localized services 155 are completed. The list is not an exhaustive list and UE 802 can stop using the network resources for localized services 155 due to other reasons e.g., UE 802 loses coverage, power off.

When large number of UEs 802 move to other network (e.g. HPLMN, VPLMN or another SNPN) or other network resources within a relatively short timeframe, the total signalling involved can cause signalling overload in the target network.

Existing mechanisms for Control Plane Load Control, Congestion and Overload Control described in clause 5.19 of [TS23501] and access control and barring described in clause 5.2.5 of [TS23501] can be used to mitigate the signalling overload caused by returning UEs 802. For further enhancement of mitigation of signalling overload, additional mechanisms can be implemented to ensure spreading of the load that returning UEs 802 cause. Such mechanisms are implementation-specific, but some guidelines that can be considered include: (i) the time validity of the network selection information given to a UE 802 can be set somewhat longer than the actual duration of the service (e.g., users will by themselves disable localized service and the UE 802 then stops using the connectivity to access the localized service, thus causing the UE 802 to be moved, for example, by performing normal network selection); (ii) the time validity of the network selection information given to a UE 802 can be different for each UE 802 so that each UE 802 performs network selection at a different time to distribute returning UEs 802; (iii) when the AMF 844 after end of localized services 155 triggers deregistration of UEs 802, the deregistration requests can be sent at a certain rate in an adaptive and distributed manner, with the effect that the signalling load on both the source network and the target network is limited; and/or (iv) when the AMF 844 after end of localized services 155 triggers UE 802 configuration update procedure (e.g., to remove S-NSSAI from the Allowed NSSAI (if dedicated S-NSSAI is used for the localized service), the requests can be sent at a certain rate, with the effect that the signalling load in the network is limited).

### 2. Network, System, and Device Configurations and Arrangements

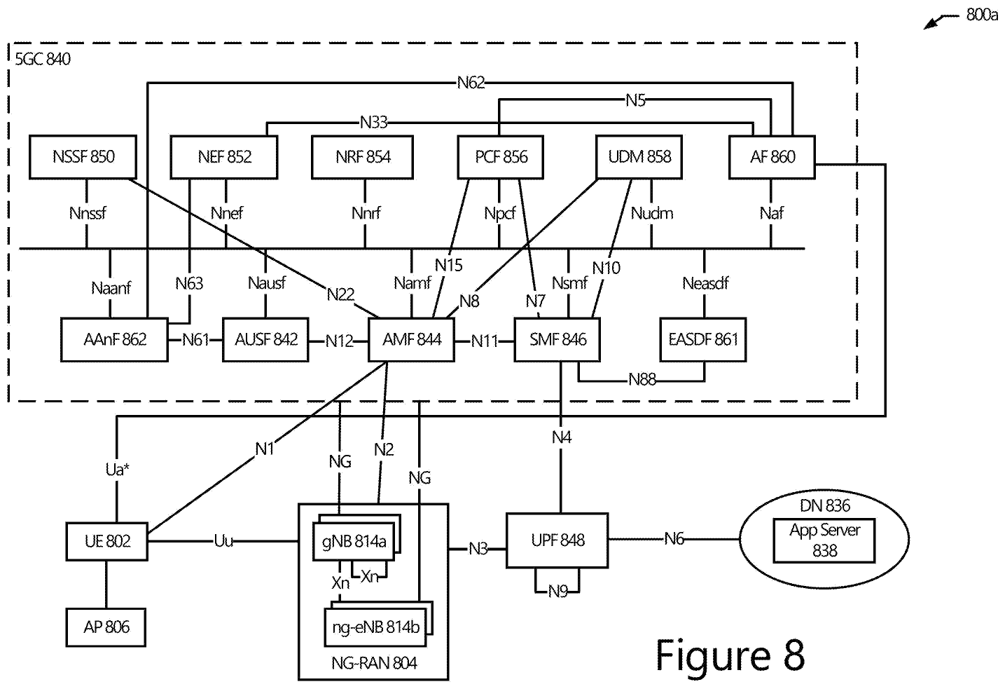

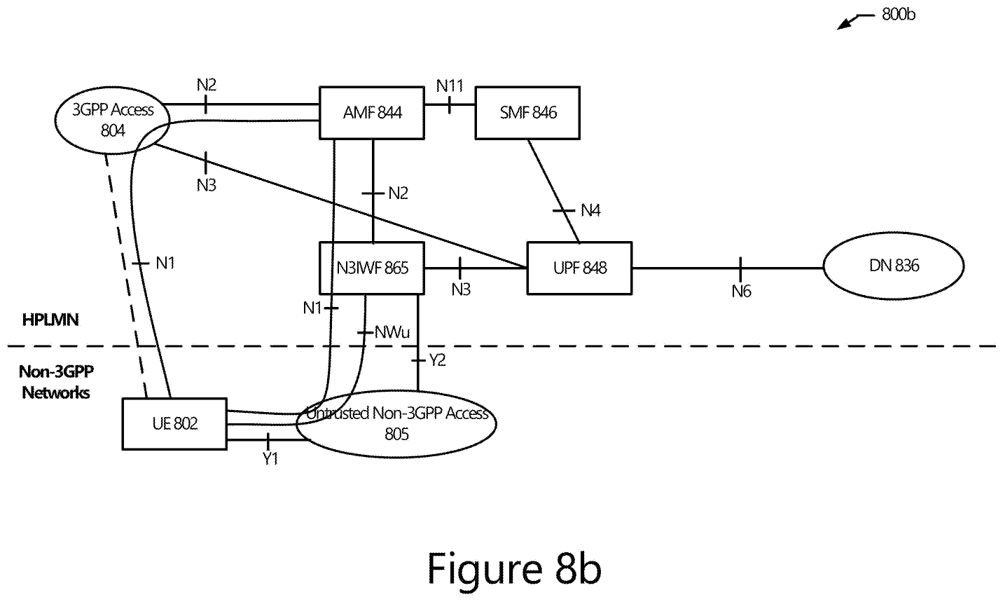

FIG. 8a depicts an example network architecture 800a. The network 800a may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 800a includes a UE 802, which is any mobile or non-mobile computing device designed to communicate with a RAN 804 via an over-the-air connection. The UE 802 is communicatively coupled with the RAN 804 by a Uu interface, which may be applicable to both LTE and NR systems. Examples of the UE 802 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. The UE 802 may be the same or similar to any of the other UEs 802 discussed herein such as, for example, UE 902, hardware resources 1000, and/or any other UE discussed herein.

The network 800a may include a set of UEs 802 coupled directly with one another via a device-to-device (D2D), proximity services (ProSe), PC5, and/or sidelink (SL) interface, and/or any other suitable interface such as any of those discussed herein. These UEs 802 may be M2M, D2D, MTC, and/or IoT devices, and/or V2X systems that communicate using physical sidelink channels such as, but not limited to, PSBCH, PSDCH, PSSCH, PSCCH, PSFCH, and the like. The UE 802 may perform blind decoding attempts of SL channels/links according to the various examples herein.

In some examples, the UE 802 may additionally communicate with an AP 806 via an over-the-air (OTA) connection. The AP 806 manages a WLAN connection, which may serve to offload some/all network traffic from the RAN 804. The connection between the UE 802 and the AP 806 may be consistent with any IEEE 802.11 protocol. Additionally, the UE 802, RAN 804, and AP 806 may utilize cellular-WLAN aggregation/integration (e.g., LWA/LWIP). Cellular-WLAN aggregation may involve the UE 802 being configured by the RAN 804 to utilize both cellular radio resources and WLAN resources.

The RAN 804 includes one or more network access nodes (NANs) 814 (also referred to as “RAN nodes 814”). The NANs 814 terminate air-interface(s) for the UE 802 by providing access stratum protocols including RRC, PDCP, RLC, MAC, and PHY/L1 protocols. In this manner, the NAN 814 enables data/voice connectivity between a core network (CN) 840 and the UE 802. The NANs 814 may be a macrocell base station or a low power base station for providing femtocells, picocells or other like cells having smaller coverage areas, smaller user capacity, or higher bandwidth compared to macrocells; or some combination thereof. In these implementations, a NAN 814 may be referred to as a base station (BS), next generation nodeB (gNB), RAN node, eNodeB (eNB), next generation (ng)-eNB, NodeB, RSU, TRP, and/or the like.

One example implementation is a “CU/DU split” architecture where the NANs 814 are embodied as a gNB-Central Unit (CU) that is communicatively coupled with one or more gNB-Distributed Units (DUs), where each DU may be communicatively coupled with one or more Radio Units (RUS) (also referred to as RRHs, RRUs, or the like). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The NANs 814 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The set of NANs 814 are coupled with one another via respective X2 interfaces if the RAN 804 is an LTE RAN or Evolved Universal Terrestrial Radio Access Network (E-UTRAN) 810, or respective Xn interfaces if the RAN 804 is a NG-RAN 804. The X2/Xn interfaces, which may be separated into control/user plane interfaces in some examples, may allow the ANs to communicate information related to handovers, data/context transfers, mobility, load management, interference coordination, and the like.

The ANs of the RAN 804 may each manage one or more cells, cell groups, component carriers, and the like to provide the UE 802 with an air interface for network access. The UE 802 may be simultaneously connected with a set of cells provided by the same or different NANs 814 of the RAN 804. For example, the UE 802 and RAN 804 may use carrier aggregation to allow the UE 802 to connect with a set of component carriers, each corresponding to a Pcell or Scell. In dual connectivity scenarios, a first AN 808 may be a master node that provides an MCG and a second AN 808 may be secondary node that provides an SCG. The first/second NANs 814 may be any combination of eNB, gNB, ng-eNB, and the like.

The RAN 804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 802 provide radio information to one or more NANs 814 and/or one or more edge compute nodes (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 802 current location). As examples, the measurements collected by the UEs 802 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (Eb/N0), energy per chip to interference power density ratio (Ec/I0), energy per chip to noise power density ratio (Ec/N0), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP 806 or RAN node 808 reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (Mar. 31, 2022) (“[TS36214]”), 3GPP TS 38.215 v17.3.0 (Mar. 30, 2023) (“[TS38215]”), 3GPP TS 38.314 v17.2.0 (Jan. 13, 2023) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by one or more NANs 814 and provided to the edge compute node(s).

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, and the like); measurements related to RRC (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); measurements related to Registration Management (RM); measurements related to Session Management (SM) (e.g., number of PDU sessions requested to setup; number of PDU sessions successfully setup; number of PDU sessions failed to setup, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 802, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (LIM); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v18.2.0 (Mar. 30, 2023) (“[TS28552]”), 3GPP TS 32.425 v17.1.0 (Jun. 24, 2021) (“[TS32425]”), and/or the like.

The radio information may be reported in response to a trigger event and/or on a periodic basis. Additionally or alternatively, individual UEs 802 report radio information either at a low periodicity or a high periodicity depending on a data transfer that is to take place, and/or other information about the data transfer. Additionally or alternatively, the edge compute node(s) may request the measurements from the NANs 814 at low or high periodicity, or the NANs 814 may provide the measurements to the edge compute node(s) at low or high periodicity. Additionally or alternatively, the edge compute node(s) may obtain other relevant data from other edge compute node(s), core network functions (NFs), application functions (AFs), and/or other UEs 802 such as Key Performance Indicators (KPIs), with the measurement reports or separately from the measurement reports.

Additionally or alternatively, in cases where is discrepancy in the observation data from one or more UEs, one or more RAN nodes, and/or core network NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

The UE 802 can also perform determine reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 802 can include those discussed in 3GPP TS 38.211 v17.4.0 (Jan. 4, 2023) (“[TS38211]”), 3GPP TS 38.212 v17.5.0 (Mar. 30, 2023) (“[TS38212]”), 3GPP TS 38.213 v17.5.0 (Mar. 30, 2023) (“[TS38213]”), 3GPP TS 38.214 v17.5.0 (Mar. 30, 2023) (“[TS38214]”), [TS38215], 3GPP TS 38.101-1 v18.1.0 (Apr. 7, 2023) (“[TS38101-1]”), 3GPP TS 38.104 v18.1.0 (Apr. 7, 2023) (“[TS38104]”), 3GPP TS 38.133 v18.1.0 (Apr. 7, 2023) (“[TS38133]”), [TS38331], and/or other the like. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), and sounding reference signal (SRS).

In any of the examples discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., MAMS [RFC8743]), IEEE/WiFi (e.g., [IEEE80211], and the like), and/or any other like standards such as those discussed herein.

In some examples, the RAN 804 is an E-UTRAN with one or more eNBs, and provides an LTE air interface (Uu) with the parameters and characteristics at least as discussed in 3GPP TS 36.300 v17.2.0 (Sep. 30, 2022) (“[TS36300]”). In some examples, the RAN 804 is an next generation (NG)-RAN 804 with a set of RAN nodes 814 (including gNBs 814a and ng-eNBs 814b). Each gNB 814a connects with 5G-enabled UEs 802 using a 5G-NR Uu interface with parameters and characteristics as discussed in [TS38300], among many other 3GPP standards, including any of those discussed herein. Where the NG-RAN 804 includes a set of ng-eNBs 814b, the one or more ng-eNBs 814b connect with a UE 802 via the 5G Uu and/or LTE Uu interface. The gNBs 814a and the ng-eNBs 814b connect with the 5GC 840 through respective NG interfaces, which include an N2 interface, an N3 interface, and/or other interfaces. The gNBs 814a and the ng-eNBs 814b are connected with each other over an Xn interface. Additionally, individual gNBs 814a are connected to one another via respective Xn interfaces, and individual ng-eNBs 814b are connected to one another via respective Xn interfaces. In some examples, the NG interface may be split into two parts, an NG user plane (NG-U) interface, which carries traffic data between the nodes of the NG-RAN 804 and a UPF 848 (e.g., N3 interface), and an NG control plane (NG-C) interface, which is a signaling interface between the nodes of the NG-RAN 804 and an AMF 844 (e.g., N2 interface).

The NG-RAN 804 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a DL resource grid that includes PSS/SSS/PBCH.

The 5G-NR air interface may utilize BWPs for various purposes. For example, BWP can be used for dynamic adaptation of the SCS. For example, the UE 802 can be configured with multiple BWPs where each BWP configuration has a different SCS. When a BWP change is indicated to the UE 802, the SCS of the transmission is changed as well. Another use case example of BWP is related to power saving. In particular, multiple BWPs can be configured for the UE 802 with different amount of frequency resources (e.g., PRBs) to support data transmission under different traffic loading scenarios. A BWP containing a smaller number of PRBs can be used for data transmission with small traffic load while allowing power saving at the UE 802 and in some cases at the gNB 814a. A BWP containing a larger number of PRBs can be used for scenarios with higher traffic load.

In some implementations, individual gNBs 814a can include a gNB-CU and a set of gNB-DUs. Additionally or alternatively, gNBs 814a can include one or more RUs. In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U. Similarly, individual ng-eNBs 814b can include an ng-eNB-CU and a set of ng-eNB-DUs. In these implementations, the ng-eNB-CU and each ng-eNB-DU are connected to one another via respective W1 interface. An ng-eNB can include an ng-eNB-CU-CP, one or more ng-eNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via the W1-C interface, and to an ng-eNB-CU-UP via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP, and for EN-DC, MeNB or SgNB depending on the bearer split) performs user inactivity monitoring and further informs its inactivity or (re)activation to the node having control plane connection towards the core network (e.g., over E1, X2, or the like). The node hosting the RLC protocol layer (e.g., gNB-DU) may perform user inactivity monitoring and further inform its inactivity or (re) activation to the node hosting the control plane (e.g., gNB-CU or gNB-CU-CP).

In these implementations, the NG-RAN 804, is layered into a Radio Network Layer (RNL) and a Transport Network Layer (TNL). The NG-RAN 804 architecture (e.g., the NG-RAN logical nodes and interfaces between them) is part of the RNL. For each NG-RAN interface (e.g., NG, Xn, F1, and the like) the related TNL protocol and the functionality are specified. The TNL provides services for user plane transport and/or signaling transport. In NG-Flex configurations, each NG-RAN node is connected to all AMFs 844 of AMF sets within an AMF region supporting at least one slice also supported by the NG-RAN node. The AMF Set and the AMF Region are defined in [TS23501].

The RAN 804 is communicatively coupled to CN 840 that includes network elements and/or network functions (NFs) to provide various functions to support data and telecommunications services to customers/subscribers (e.g., UE 802). The components of the CN 840 may be implemented in one physical node or separate physical nodes. In some examples, NFV may be utilized to virtualize any or all of the functions provided by the network elements of the CN 840 onto physical compute/storage resources in servers, switches, and the like. A logical instantiation of the CN 840 may be referred to as a network slice, and a logical instantiation of a portion of the CN 840 may be referred to as a network sub-slice.

In the example of FIG. 8, the CN 840 is a 5GC 840 including an Authentication Server Function (AUSF) 842, Access and Mobility Management Function (AMF) 844, Session Management Function (SMF) 846, User Plane Function (UPF) 848, Network Slice Selection Function (NSSF) 850, Network Exposure Function (NEF) 852, Network Repository Function (NRF) 854, Policy Control Function (PCF) 856, Unified Data Management (UDM) 858, Unified Data Repository (UDR), Application Function (AF) 860, and AKMA Anchor Function (AAnF) 862 coupled with one another over various interfaces as shown. The NFs in the 5GC 840 are briefly introduced as follows.

The AAnF 862 is the anchor function in the home public land mobile network (HPLMN). The AAnF 862 stores the AKMA Anchor Key (K_{AKMA}) and SUPI for AKMA service, which is received from the AUSF 842 after the UE 802 completes a successful 5G primary authentication. The AAnF 862 also generates the key material to be used between the UE 802 and the AF 860 and maintains UE AKMA contexts. The AKMA context includes a set of parameters stored in AanF 862, including SUPI, K_{AKMA}, and an AKMA Key Identifier (A-KID). The A-KID is a globally unique identifier that is usable as a key identifier in protocols used in the reference point Ua*. An AKMA AF 860 is able to identify the AAnF 862 serving the UE 802 from the A-KID. The AAnF 862 sends SUPI of the UE 802 to the AF 860 located inside the operator's network according to the AF request or sends to NEF 852.

The AAnF 862 exhibits or otherwise includes an Naanf service-based interface exhibited by AAnF 862. The AAnF 862 interacts with the AUSF 842 and the AF 860 using service-based interfaces. When the AF 860 is located in the operator's network, the AAnF 862 uses the service-based interface to communicate with the AF 860 directly. When the AF 860 is located outside the operator's network, the NEF 852 is used to exchange the messages between the AF 860 and the AAnF 862. Furthermore, various reference points are included to support AKMA, including the N61 reference point between the AAnF 862 and the AUSF 842; the N62 reference point between the AAnF 862 and an internal AF 860; the N63 reference point between the AAnF 862 and the NEF 852; and the Ua* reference point between the UE 802 and an AF 860.

The Ua* reference point is application specific. The Ua* protocol is able to carry an A-KID and is able to handle the expiration of a K_{AF}; the UE 802 and the AKMA AF 860 is able to secure the reference point Ua* using the AKMA Application Key derived from the AKMA Anchor Key. The exact method of securing the reference point Ua* depends on the application protocol used over reference point Ua*. AKAM also includes a key hierarchy, which includes the following keys: AKMA AUSF Key (K_{AUSF}), K_{AKMA}, and AKMA Application Key (K_{AF}). The K_{AUSF} is generated by AUSF 842 as specified in clause 6.1 of 3GPP TS 33.501. The keys for the AAnF 862 includes the K_{AKMA}, which is a key derived by ME and the AUSF 842 from the K_{AUSF}. The keys for an AF 860 include the K_{AF}, which is a key derived by the ME and the AAnF 862 from the K_{AKMA}. The K_{AKMA} and the K_{AF} are derived according to the procedures of clauses 6.1 and 6.2 in 3GPP TS 35.535 v17.8.0 (Mar. 30, 2023) (“[TS35535]”).

The K_{AKMA} and A-KID are valid until the next successful primary authentication is performed (implicit lifetime), in which case the K_{AKMA} and A-KID are replaced. The K_{AF} uses explicit lifetimes based on the operator's policy. The lifetime of the K_{AF} is sent by the AAnF 862 as described in clauses 6.2 and 6.3 of [TS35535]. In case that a new K_{AKMA} is established, the K_{AF} can continue to be used for the duration of the current application session or until its lifetime expires, whichever comes first. When the K_{AF} lifetime expires, a new K_{AF} is established based on the current K_{AKMA}. When the K_{AF} lifetime expires and the K_{AKMA} has not changed in AAnF 862, according to the Annex A.4 of [TS35535], the K_{AF} which is established based on the current K_{AKMA} is not a new one.

The AUSF 842 stores data for authentication of UE 802 and handle authentication-related functionality. The AUSF 842 may facilitate a common authentication framework for various access types. In addition to the functionality defined in [TS23501], the AUSF 842 provides the SUPI and AKMA key material (A-KID, K_{AKMA}) of the UE 802 to the AAnF 862, and the AUSF 842 performs AAnF selection.

The AMF 844 allows other functions of the 5GC 840 to communicate with the UE 802 and the RAN 804 and to subscribe to notifications about mobility events w.r.t the UE 802. The AMF 844 is also responsible for registration management (e.g., for registering UE 802), connection management, reachability management, mobility management, lawful interception of AMF-related events, and access authentication and authorization. The AMF 844 provides transport for SM messages between the UE 802 and the SMF 846, and acts as a transparent proxy for routing SM messages. AMF 844 also provides transport for SMS messages between UE 802 and an SMSF. AMF 844 interacts with the AUSF 842 and the UE 802 to perform various security anchor and context management functions. Furthermore, AMF 844 is a termination point of a RAN-CP interface, which includes the N2 reference point between the RAN 804 and the AMF 844. The AMF 844 is also a termination point of NAS (N1) signaling, and performs NAS ciphering and integrity protection.

The AMF 844 also supports NAS signaling with the UE 802 over an N3IWF interface. The N3IWF provides access to untrusted entities. N3IWF may be a termination point for the N2 interface between the (R)AN 804 and the AMF 844 for the control plane, and may be a termination point for the N3 reference point between the (R)AN 804 and the 848 for the user plane. As such, the AMF 844 handles N2 signaling from the SMF 846 and the AMF 844 for PDU sessions and QoS, encapsulate/de-encapsulate packets for IPSec and N3 tunneling, marks N3 user-plane packets in the UL, and enforces QoS corresponding to N3 packet marking taking into account QoS requirements associated with such marking received over N2. N3IWF may also relay UL and DL control-plane NAS signaling between the UE 802 and AMF 844 via an N1 reference point between the UE 802 and the AMF 844, and relay UL and DL user-plane packets between the UE 802 and UPF 848. The N3IWF also provides mechanisms for IPsec tunnel establishment with the UE 802. The AMF 844 may exhibit an Namf service-based interface, and may be a termination point for an N14 reference point between two AMFs 844 and an N17 reference point between the AMF 844 and a 5G-EIR (not shown by FIG. 8). In addition to the functionality of the AMF 844 described herein, the AMF 844 may provide support for Network Slice restriction and Network Slice instance restriction based on NWDAF analytics.

The SMF 846 is responsible for SM (e.g., session establishment, tunnel management between UPF 848 and AN 808); UE IP address allocation and management (including optional authorization); selection and control of UP function; configuring traffic steering at UPF 848 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 844 over N2 to AN 808; and determining SSC mode of a session. SM refers to management of a PDU session, and a PDU session or “session” refers to a PDU connectivity service that provides or enables the exchange of PDUs between the UE 802 and the DN 836. The SMF 846 may also include the following functionalities to support edge computing enhancements (see e.g., [TS23548]): selection of EASDF 861 and provision of its address to the UE as the DNS server for the PDU session; usage of EASDF 861 services as defined in [TS23548]; and for supporting the application layer architecture defined in [TS23558], provision and updates of ECS address configuration information to the UE. Discovery and selection procedures for EASDFs 861 is discussed in [TS23501] § 6.3.23.

The UPF 848 acts as an anchor point for intra-RAT and inter-RAT mobility, an external PDU session point of interconnect to data network 836, and a branching point to support multi-homed PDU session. The UPF 848 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 848 may include an UL classifier to support routing traffic flows to a data network.

The NSSF 850 selects a set of network slice instances serving the UE 802. The NSSF 850 also determines allowed NSSAI and the mapping to the subscribed S-NSSAIs, if needed. The NSSF 850 also determines an AMF set to be used to serve the UE 802, or a list of candidate AMFs 844 based on a suitable configuration and possibly by querying the NRF 854. The selection of a set of network slice instances for the UE 802 may be triggered by the AMF 844 with which the UE 802 is registered by interacting with the NSSF 850; this may lead to a change of AMF 844. The NSSF 850 interacts with the AMF 844 via an N22 reference point; and may communicate with another NSSF in a visited network via an N3 1 reference point (not shown).

The NEF 852 securely exposes services and capabilities provided by 3GPP NFs for third party, internal exposure/re-exposure, AFs 860, edge computing networks/frameworks, and the like. In such examples, the NEF 852 may authenticate, authorize, or throttle the AFs 860. The NEF 852 stores/retrieves information as structured data using the Nudr interface to a Unified Data Repository (UDR). The NEF 852 also translates information exchanged with the AF 860 and information exchanged with internal NFs. For example, the NEF 852 may translate between an AF-Service-Identifier and an internal 5GC information, such as DNN, S-NSSAI, as described in clause 5.6.7 of [TS23501]. In particular, the NEF 852 handles masking of network and user sensitive information to external AF's 860 according to the network policy. The NEF 852 also receives information from other NFs based on exposed capabilities of other NFs. This information may be stored at the NEF 852 as structured data, or at a data storage NF using standardized interfaces. The stored information can then be re-exposed by the NEF 852 to other NFs and AFs 860, or used for other purposes such as analytics. For example, NWDAF analytics may be securely exposed by the NEF 852 for external party. Furthermore, data provided by an external party may be collected by the NWDAF via the NEF 852 for analytics generation purpose. The NEF 852 handles and forwards requests and notifications between the NWDAF and AF(s) 860. In addition to the functionality defined in [TS23501], the NEF 852 also enables and authorizes the external AF assessing AKMA service and forwards the request towards the AAnF 862, and performs AAnF selection.

The NRF 854 supports service discovery functions, receives NF discovery requests from NF instances, and provides information of the discovered NF instances to the requesting NF instances. The NRF 854 also maintains NF profiles of available NF instances and their supported services. The NF profile of NF instance maintained in the NRF 854 includes the following information: NF instance ID; NF type; PLMN ID in the case of PLMN, PLMN ID+NID in the case of SNPN; Network Slice related Identifier(s) (e.g., S-NSSAI, NSI ID); an NF's network address(es) (e.g., FQDN, IP address, and/or the like), NF capacity information, NF priority information (e.g., for AMF selection), NF set ID, NF service set ID of the NF service instance; NF specific service authorization information; names of supported services, if applicable; endpoint address(es) of instance(s) of each supported service; identification of stored data/information (e.g., for UDR profile and/or other NF profiles); other service parameter(s) (e.g., DNN or DNN list, LADN DNN or LADN DNN list, notification endpoint for each type of notification that the NF service is interested in receiving, and/or the like); location information for the NF instance (e.g., geographical location, data center, and/or the like); TAI(s); NF load information; Routing Indicator, Home Network Public Key identifier, for UDM 858 and AUSF 842; for UDM 858, AUSF 842, and NSSAAF in the case of access to an SNPN using credentials owned by a Credentials Holder with AAA Server, identification of Credentials Holder (e.g., the realm of the Network Specific Identifier based SUPI); for UDM 858 and AUSF 842, and if UDM 858/AUSF 842 is used for access to an SNPN using credentials owned by a Credentials Holder, identification of Credentials Holder (e.g., the realm if network specific identifier based SUPI is used or the MCC and MNC if IMSI based SUPI is used); for AUSF 842 and NSSAAF in the case of SNPN Onboarding using a DCS with AAA server, identification of DCS (e.g., the realm of the Network Specific Identifier based SUPI); for UDM 858 and AUSF 842, and if UDM 858/AUSF 842 is used as DCS in the case of SNPN Onboarding, identification of DCS ((e.g., the realm if Network Specific Identifier based SUPI, or the MCC and MNC if IMSI based SUPI); one or more GUAMI(s), in the case of AMF 844; for the UPF 848, see clause 5.2.7.2.2 of [TS23502]; UDM Group ID, range(s) of SUPIs, range(s) of GPSIs, range(s) of internal group identifiers, range(s) of external group identifiers for UDM 858; UDR Group ID, range(s) of SUPIs, range(s) of GPSIs, range(s) of external group identifiers for UDR; AUSF Group ID, range(s) of SUPIs for AUSF 842; PCF Group ID, range(s) of SUPIs for PCF 856; HSS Group ID, set(s) of IMPIs, set(s) of IMPU, set(s) of IMSIs, set(s) of PSIs, set(s) of MSISDN for HSS; event ID(s) supported by AFs 860, in the case of NEF 852; event Exposure service supported event ID(s) by UPF 848; application identifier(s) supported by AFs 860, in the case of NEF 852; range(s) of external identifiers, or range(s) of external group identifiers, or the domain names served by the NEF, in the case of NEF 852; additionally the NRF 854 may store a mapping between UDM Group ID and SUPI(s), UDR Group ID and SUPI(s), AUSF Group ID and SUPI(s) and PCF Group ID and SUPI(s), to enable discovery of UDM 858, UDR, AUSF 842 and PCF 856 using SUPI, SUPI ranges as specified in clause 6.3 of [TS23501], and/or interact with UDR to resolve the UDM Group ID/UDR Group ID/AUSF Group ID/PCF Group ID based on UE identity (e.g., SUPI)); IP domain list as described in clause 6.1.6.2.21 of 3GPP TS 29.510 v18.2.0 (Mar. 29, 2023) (“[TS29510]”), Range(s) of (UE) IPv4 addresses or Range(s) of (UE) IPv6 prefixes, Range(s) of SUPIs or Range(s) of GPSIs or a BSF Group ID, in the case of BSF; SCP Domain the NF belongs to; DCCF Serving Area information, NF types of the data sources, NF Set IDs of the data sources, if available, in the case of DCCF 863; supported DNAI list, in the case of SMF 846; for SNPN, capability to support SNPN Onboarding in the case of AMF and capability to support User Plane Remote Provisioning in the case of SMF 846; IP address range, DNAI for UPF 848; additional V2X related NF profile parameters are defined in 3GPP TS 23.287; additional ProSe related NF profile parameters are defined in 3GPP TS 23.304; additional MBS related NF profile parameters are defined in 3GPP TS 23.247; additional UAS related NF profile parameters are defined in TS 23.256; among many others discussed in [TS23501]. In some examples, service authorization information provided by an OAM system is also included in the NF profile in the case that, for example, an NF instance has an exceptional service authorization information. For NWDAF, the NF profile includes: supported analytics ID(s), possibly per service, NWDAF serving area information (e.g., a list of TAIs for which the NWDAF can provide services and/or data), Supported Analytics Delay per Analytics ID (if available), NF types of the NF data sources, NF Set IDs of the NF data sources, if available, analytics aggregation capability (if available), analytics metadata provisioning capability (if available), ML model filter information parameters S-NSSAI(s) and area(s) of interest for the trained ML model(s) per analytics ID(s) (if available), federated learning (FL) capability type (e.g., FL server or FL client, if available), Time interval supporting FL (if available). The NWDAF's serving area information is common to all its supported analytics IDs. The analytics IDs supported by the NWDAF may be associated with a supported analytics delay, for example, the analytics report can be generated with a time (including data collection delay and inference delay) in less than or equal to the supported analytics delay. The determination of supported analytics delay, and how the NWDAF avoid updating its supported analytics delay in NRF frequently may be NWDAF-implementation specific.

The PCF 856 provides policy rules to control plane functions to enforce them, and may also support unified policy framework to govern network behavior. The PCF 856 may also implement a front end to access subscription information relevant for policy decisions in a UDR 859 of the UDM 858. In addition to communicating with functions over reference points as shown, the PCF 856 exhibit an Npcf service-based interface.

The UDM 858 handles subscription-related information to support the network entities' handling of communication sessions, and stores subscription data of UE 802. For example, subscription data may be communicated via an N8 reference point between the UDM 858 and the AMF 844. The UDM 858 may include two parts, an application front end and a UDR. The UDR may store subscription data and policy data for the UDM 858 and the PCF 856, and/or structured data for exposure and application data (including PFDs for application detection, application request information for multiple UEs 802) for the NEF 852. The Nudr service-based interface may be exhibited by the UDR to allow the UDM 858, PCF 856, and NEF 852 to access a particular set of the stored data, as well as to read, update (e.g., add, modify), delete, and subscribe to notification of relevant data changes in the UDR. The UDM 858 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 858 may exhibit the Nudm service-based interface. In addition to the functionality defined in [TS23501], the UDM 858 also stores AKMA subscription data of the subscriber. The AKMA subscription data is the data in the home operator's network (e.g., home network 120) indicating whether or not the subscriber is allowed to use AKMA.

Edge Application Server Discovery Function (EASDF) 861 exhibits an Neasdf service-based interface, and is connected to the SMF 846 via an N88 interface. One or multiple EASDF instances may be deployed within a PLMN, and interactions between 5GC NF(s) and the EASDF 861 take place within a PLMN. The EASDF 861 includes one or more of the following functionalities: registering to NRF 854 for EASDF 861 discovery and selection; handling the DNS messages according to the instruction from the SMF 846; and/or terminating DNS security, if used. Handling the DNS messages according to the instruction from the SMF 846 includes one or more of the following functionalities: receiving DNS message handling rules and/or BaselineDNSPattern from the SMF 846; exchanging DNS messages from/with the UE 802; forwarding DNS messages to C-DNS or L-DNS for DNS query; adding EDNS client subnet (ECS) option into DNS query for an FQDN; reporting to the SMF 846 the information related to the received DNS messages; and/or buffering/discarding DNS messages from the UE 802 or DNS Server. The EASDF has direct user plane connectivity (e.g., without any NAT) with the PSA UPF over N6 for the transmission of DNS signaling exchanged with the UE. The deployment of a NAT between EASDF 861 and PSA UPF 848 may or may not be supported. Additional aspects of the EASDF 861 are discussed in [TS23548].

AF 860 provides application influence on traffic routing, provide access to NEF 852, and interact with the policy framework for policy control. The AF 860 may influence UPF 848 (re) selection and traffic routing. Based on operator deployment, when AF 860 is considered to be a trusted entity, the network operator may permit AF 860 to interact directly with relevant NFs. In some implementations, the AF 860 is used for edge computing implementations. An NF that needs to collect data from an AF 860 may subscribe/unsubscribe to notifications regarding data collected from an AF 860, either directly from the AF 860 or via NEF 852. The data collected from an AF 860 is used as input for analytics by the NWDAF. The details for the data collected from an AF 860 as well as interactions between NEF 852, AF 860 and NWDAF are described in 3GPP TS 23.288. In addition to the functionality defined in [TS23501], an AF 860 with the AKMA service enabling requests for AKMA Application Key, called K_{AF}, from the AAnF using A-KID. The AF 860 is also authenticated and authorized by the operator network before providing the K_{AF} to the AF 860. When located inside the operator's network, the AF 860 performs the AAnF selection.

The 5GC 840 may enable edge computing by selecting operator/3rd party services to be geographically close to a point that the UE 802 is attached to the network. This may reduce latency and load on the network. In edge computing implementations, the 5GC 840 may select a UPF 848 close to the UE 802 and execute traffic steering from the UPF 848 to DN 836 via the N6 interface. This may be based on the UE subscription data, UE location, and information provided by the AF 860, which allows the AF 860 to influence UPF (re) selection and traffic routing.

The data network (DN) 836 may represent various network operator services, Internet access, or third party services that may be provided by one or more servers including, for example, application (app)/content server 838. The DN 836 may be an operator external public, a private PDN, or an intra-operator packet data network, for example, for provision of IMS services. In this example, the app server 838 can be coupled to an IMS via an S-CSCF or the I-CSCF. In some implementations, the DN 836 may represent one or more local area DNs (LADNs), which are DNs 836 (or DN names (DNNs)) that is/are accessible by a UE 802 in one or more specific areas. Outside of these specific areas, the UE 802 is not able to access the LADN/DN 836.

Additionally or alternatively, the DN 836 may be an edge DN 836, which is a (local) DN that supports the architecture for enabling edge applications. In these examples, the app server 838 may represent the physical hardware systems/devices providing app server functionality and/or the application software resident in the cloud or at an edge compute node that performs server function(s). In some examples, the app/content server 838 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 804 or RAN nodes 814. For example, the edge compute nodes can provide a connection between the RAN 804 and UPF 848 in the 5GC 840. The edge compute nodes can use one or more NFV instances instantiated on virtualization infrastructure within the edge compute nodes to process wireless connections to and from the RAN 814 and UPF 848.

In some implementations, the edge compute nodes provide a distributed computing environment for application and service hosting, and also provide storage and processing resources so that data and/or content can be processed in close proximity to subscribers (e.g., users of UEs 802) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the UEs 802, CN 840, DN 836, and/or server(s) 838, or vice versa. For example, a device application or client application operating in a UE 802 may offload application tasks or workloads to one or more edge compute nodes. In another example, an edge compute node may offload application tasks or workloads to a set of UEs 802 (e.g., for distributed machine learning computation and/or the like).

The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 802. The VI of the edge compute nodes provide virtualized environments and virtualized resources for the edge hosts, and the edge computing applications may run as VMs and/or application containers on top of the VI.

In one example implementation, the ECT is and/or operates according to the MEC framework, as discussed in ETSI GR MEC 001 v3.1.1 (January 2022), ETSI GS MEC 003 v3.1.1 (March 2022), ETSI GS MEC 009 v3.1.1 (June 2021), ETSI GS MEC 010-1 v1.1.1 (October 2017), ETSI GS MEC 010-2 v2.2.1 (February 2022), ETSI GS MEC 011 v2.2.1 (December 2020), ETSI GS MEC 012 V2.2.1 (February 2022), ETSI GS MEC 013 V2.2.1 (January 2022), ETSI GS MEC 014 v2.1.1 (March 2021), ETSI GS MEC 015 v2.1.1 (June 2020), ETSI GS MEC 016 v2.2.1 (April 2020), ETSI GS MEC 021 v2.2.1 (February 2022), ETSI GR MEC 024 v2.1.1 (November 2019), ETSI GS MEC 028 V2.2.1 (July 2021), ETSI GS MEC 029 v2.2.1 (January 2022), ETSI MEC GS 030 v2.1.1 (April 2020), and ETSI GR MEC 031 v2.1.1 (October 2020) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (March 2021), ETSI GS NFV 002 V1.2.1 (December 2014), ETSI GR NFV 003 V1.6.1 (March 2021), ETSI GS NFV 006 V2.1.1 (January 2021), ETSI GS NFV-INF 001 V1.1.1 (January 2015), ETSI GS NFV-INF 003 V1.1.1 (December 2014), ETSI GS NFV-INF 004 V1.1.1 (January 2015), ETSI GS NFV-MAN 001 v1.1.1 (December 2014), and/or Israel et al., OSM Release FIVE Technical Overview, ETSI OPEN SOURCE MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads//NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (Dec. 23, 2021) (“[TS28533]”), the contents of each of which are hereby incorporated by reference in their entireties.

In another example implementation, the ECT is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI/ML. Various aspects of the O-RAN architecture are described in O-RAN Working Group 1 (Use Cases and Overall Architecture): O-RAN Architecture Description, O-RAN ALLIANCE WG1, O-RAN Architecture Description v08.00, Release R003 (March 2023); O-RAN Operations and Maintenance Architecture Specification v04.00, O-RAN ALLIANCE WG1 (February 2021); O-RAN Working Group 2 AI/ML workflow description and requirements v01.03 O-RAN ALLIANCE WG2 (October 2021); O-RAN Working Group 2 (Non-RT RIC and A1 interface WG): R1 interface: General Aspects and Principles 4.0, v04.00, Release R003 (March 2023); O-RAN Working Group 2 (Non-RT RIC and A1 interface WG) Non-RT RIC Architecture v02.01 (October 2022); O-RAN Working Group 3 (Near-Real-time RAN Intelligent Controller and E2 Interface Working Group): Near-RT RIC Architecture, v04.00, Release R003 (March 2023); O-RAN Working Group 4 (Open Fronthaul Interfaces WG) Control, User and Synchronization Plane Specification, v11.00, Release R003 (March 2023); O-RAN Fronthaul Working Group 4 Cooperative Transport Interface Transport Control Plane Specification, v03.00 (October 2022); O-RAN Fronthaul Working Group 4 Cooperative Transport Interface Transport Management Plane Specification, v11.00, Release R003 (March 2023); O-RAN Open X-haul Transport Working Group Management interfaces for Transport Network Elements, v05.00, Release R003 (March 2023); O-RAN Open Transport Working Group 9 Xhaul Packet Switched Architectures and Solutions, v03.00, Release R003 (March 2023); O-RAN Open X-haul Transport Working Group Synchronization Architecture and Solution Specification, v03.00 (October 2022); O-RAN Open Xhaul Transport WG9 WDM-based Fronthaul Transport, v03.00, Release R003 (March 2023); O-RAN Operations and Maintenance Architecture, v08.00, Release R003 (March 2023); O-RAN Operations and Maintenance Interface Specification, v09.00, Release R003 (March 2023) (collectively referred to as “[O-RAN]”), the contents of each of which are hereby incorporated by reference in their entireties.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v18.1.0 (Dec. 23, 2022) (“[TS23558]”), 3GPP TS 23.501 v18.0.0 (Dec. 21, 2022) (“[TS23501]”), 3GPP TS 23.502 v18.1.1 (Apr. 5, 2023) (“[TS23502]”), 3GPP TS 23.503 v18.1.0 (Apr. 5, 2023) (“[TS23503]”), 3GPP TS 23.548 v18.1.0 (Apr. 6, 2023) (“[TS23548]”), 3GPP TS 28.538 v18.2.0 (Mar. 30, 2023) (“[TS28538]”), 3GPP TR 23.700-98 v18.0.0 (Dec. 23, 2022) (“[TR23700-98]”), 3GPP TS 23.222 v18.0.0 (Dec. 23, 2022) (“[TS23222]”), 3GPP TS 33.122 v18.0.0 (Dec. 16, 2022) (“[TS33122]”), 3GPP TS 29.222 v17.1.0 (Jub. 25, 2021) (“[TS29222]”), 3GPP TS 29.522 v18.0.0 (Dec. 16, 2022) (“[TS29522]”), 3GPP TS 29.122 v18.0.0 (Dec. 16, 2022) (“[TS29122]”), 3GPP TS 23.682 v17.3.0 (Jun. 15, 2022) (“[TS23682]”), 3GPP TS 23.434 v18.3.0 (Dec. 23, 2022) (“[TS23434]”), and 3GPP TS 23.401 v18.0.0 (Dec. 21, 2022) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the ECT operates according to the Multi-Access Management Services (MAMS) framework as discussed in Kanugovi et al., Multi-Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

The interfaces of the 5GC 840 include reference points and service-based interfaces. The reference points include: N1 (between the UE 802 and the AMF 844), N2 (between RAN 814 and AMF 844), N3 (between RAN 814 and UPF 848), N4 (between the SMF 846 and UPF 848), N5 (between PCF 856 and AF 860), N6 (between UPF 848 and DN 836), N7 (between SMF 846 and PCF 856), N8 (between UDM 858 and AMF 844), N9 (between two UPFs 848), N10 (between the UDM 858 and the SMF 846), N11 (between the AMF 844 and the SMF 846), N12 (between AUSF 842 and AMF 844), N13 (between AUSF 842 and UDM 858), N14 (between two AMFs 844; not shown), N15 (between PCF 856 and AMF 844 in case of a non-roaming scenario, or between the PCF 856 in a visited network and AMF 844 in case of a roaming scenario), N16 (between two SMFs 846; not shown), and N22 (between AMF 844 and NSSF 850). Other reference point representations not shown in FIG. 8 can also be used. The service-based representation of FIG. 8 represents NFs within the control plane that enable other authorized NFs to access their services. The service-based interfaces (SBIs) include: Namf (SBI exhibited by AMF 844), Nsmf (SBI exhibited by SMF 846), Nnef (SBI exhibited by NEF 852), Npcf (SBI exhibited by PCF 856), Nudm (SBI exhibited by the UDM 858), Naf (SBI exhibited by AF 860), Nnrf (SBI exhibited by NRF 854), Nnssf (SBI exhibited by NSSF 850), Nausf (SBI exhibited by AUSF 842). Other service-based interfaces (e.g., Nudr, N5g-eir, and Nudsf) not shown in FIG. 8 can also be used. In some examples, the NEF 852 can provide an interface to edge compute nodes 836x, which can be used to process wireless connections with the RAN 814.

Although not shown by FIG. 8, the system 800a may also include NFs that are not shown such as, for example, UDR, Unstructured Data Storage Function (UDSF), Network Slice Admission Control Function (NSACF), Network Slice-specific and Stand-alone Non-Public Network (SNPN) Authentication and Authorization Function (NSSAAF), UE radio Capability Management Function (UCMF), 5G-Equipment Identity Register (5G-EIR), CHarging Function (CHF), Time Sensitive Networking (TSN) AF 860, Time Sensitive Communication and Time Synchronization Function (TSCTSF), Network Data Analytics Function (NWDAF), Data Collection Coordination Function (DCCF); Messaging Framework Adaptor Function (MFAF), Analytics Data Repository Function (ADRF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

FIG. 8b illustrates an example reference architecture 800b for 5GC 840 with untrusted non-3GPP access 805 and a Non-3GPP InterWorking Function (N3IWF) 865.

The functionality of N3IWF 865 in the case of untrusted non-3GPP access 805 includes support of Internet Protocol Secure (IPsec) tunnel establishment with the UE 802. Here, the N3IWF 865 terminates the IKEv2/IPsec protocols with the UE 802 over the NWu reference point and relays over the N2 reference point the information needed to authenticate the UE 802 and authorize its access to the 5GC 840.

The N3IWF 865 includes termination of the N2 and N3 interfaces to the 5GC 840 for control-plane and user-plane, respectively. The N3IWF 865 relays uplink and downlink control-plane NAS (N1) signalling between the UE 802 and the AMF 844, and handles N2 signalling from the SMF 846 (relayed by the AMF 844) related to PDU Sessions and QoS. The N3IWF 865 supports establishment of IPsec Security Association (IPsec SA) to support PDU Session traffic. The N3IWF 865 relays uplink and downlink user-plane packets between the UE 802 and UPF 848, which involves de-capsulation and encapsulation of packets for IPSec and N3 tunnelling. The N3IWF 865 enforces QoS corresponding to N3 packet marking, taking into account QoS requirements associated to such marking received over N2, and N3 user-plane packet marking in the uplink. The N3IWF 865 also supports local mobility anchor within untrusted non-3GPP access networks using MOBIKE per IETF RFC 4555, and includes various functionality to support AMF selection as discussed in [TS23501].

The N3IWF 865 can provide access to SNPN services via untrusted non-3GPP access network 805 according to clause 5.30 of [TS23501]. When the UE 802 registers to SNPN with credentials owned by the SNPN, the UE 802 uses the same N3IWF selection procedure as specified for access to SNPN services via PLMN in clause 6.3.6.2a of [TS23501].

UE 802 onboarding is supported as follows: When the UE 802 registers to an SNPN over untrusted non-3GPP access 805 for UE onboarding, the UE 802 may select an N3IWF 865 in the SNPN which supports UE Onboarding by using a pre-configured N3IWF FQDN used for onboarding. If the PVS is reachable from the local untrusted non-3GPP access network 805 (e.g., via the Internet) using the local IP connectivity, the UE 802 may connect directly (e.g., without being connected to an N3WIF 865) with a PVS to obtain the SNPN credentials. Additional aspects related to the N3WIF 865 are discussed in [TS23501].

The network 800b also includes the Y1 reference point between the UE 802 and the untrusted non-3GPP access 805 (e.g., WLAN and/or the like). This reference point is based on the non-3GPP access technology. The network 800b also includes the Y2 reference point between the untrusted non-3GPP access 805 and the N3IWF 865 for the transport of NWu traffic. The network 800b also includes the NWu reference point between the UE 802 and the N3IWF 865 for establishing secure tunnel(s) between the UE 802 and the N3IWF 865 so that control-plane and user-plane exchanged between the UE 802 and the 5GC 840 is transferred securely over untrusted non-3GPP access 805.

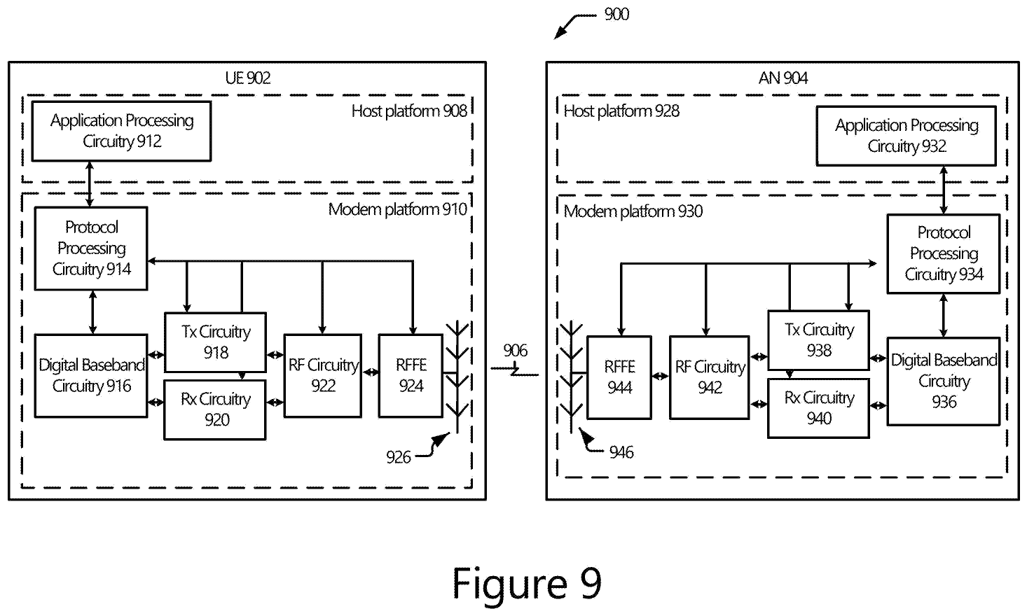

FIG. 9 illustrates a wireless network 900. The wireless network 900 includes a UE 902 in wireless communication with a NAN 904. The UE 902 may be the same or similar to, and substantially interchangeable with any of the of the UEs discussed herein such as, for example, UE 802, hardware resources 1000, and/or any other UE discussed herein. The AN 904 may be the same or similar to, and substantially interchangeable with any of the of the ANs (network access nodes (NANs)) discussed herein such as, for example, AP 806, NANs 814, RAN 804, hardware resources 1000, and/or any other AN/NAN discussed herein.

The UE 902 may be communicatively coupled with the AN 904 via connection 906. The connection YY06 is illustrated as an air interface to enable communicative coupling, and can be consistent with cellular communications protocols such as an LTE protocol or a 5G NR protocol operating at mm Wave or sub-6 GHz frequencies.

The UE 902 includes a host platform 908 coupled with a modem platform 910. The host platform 908 includes application processing circuitry 912, which may be coupled with protocol processing circuitry 914 of the modem platform 910. The application processing circuitry 912 may run various applications for the UE 902 that source/sink application data. The application processing circuitry 912 may further implement one or more layer operations to transmit/receive application data to/from a data network. These layer operations includes transport (for example UDP) and Internet (e.g., IP) operations

The protocol processing circuitry 914 may implement one or more of layer operations to facilitate transmission or reception of data over the connection 906. The layer operations implemented by the protocol processing circuitry 914 includes, for example, MAC, RLC, PDCP, RRC and NAS operations.

The modem platform 910 may further include digital baseband circuitry 916 that may implement one or more layer operations that are “below” layer operations performed by the protocol processing circuitry 914 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 910 may further include transmit circuitry 918, receive circuitry 920, RF circuitry 922, and RF front end (RFFE) 924, which includes or connect to one or more antenna panels 926. Briefly, the transmit circuitry 918 includes a digital-to-analog converter, mixer, intermediate frequency (IF) components, etc.; the receive circuitry 920 includes an analog-to-digital converter, mixer, IF components, etc.; the RF circuitry 922 includes a low-noise amplifier, a power amplifier, power tracking components, etc.; RFFE 924 includes filters (e.g., surface/bulk acoustic wave filters), switches, antenna tuners, beamforming components (e.g., phase-array antenna components), etc. The selection and arrangement of the components of the transmit circuitry 918, receive circuitry 920, RF circuitry 922, RFFE 924, and antenna panels 926 (referred generically as “transmit/receive components” or “Tx/Rx components”) may be specific to details of a specific implementation such as, for example, whether communication is TDM or FDM, in mmWave or sub-6 gHz frequencies, etc. In some examples, the transmit/receive components may be arranged in multiple parallel transmit/receive chains, may be disposed in the same or different chips/modules, etc.

In some examples, the protocol processing circuitry 914 includes one or more instances of control circuitry (not shown) to provide control functions for the transmit/receive components.

A UE reception may be established by and via the antenna panels 926, RFFE 924, RF circuitry 922, receive circuitry 920, digital baseband circuitry 916, and protocol processing circuitry 914. In some examples, the antenna panels 926 may receive a transmission from the AN 904 by receive-beamforming signals received by a set of antennas/antenna elements of the one or more antenna panels 926.

A UE transmission may be established by and via the protocol processing circuitry 914, digital baseband circuitry 916, transmit circuitry 918, RF circuitry 922, RFFE 924, and antenna panels 926. In some examples, the transmit components of the UE 904 may apply a spatial filter to the data to be transmitted to form a transmit beam emitted by the antenna elements of the antenna panels 926.

Similar to the UE 902, the AN 904 includes a host platform 928 coupled with a modem platform 930. The host platform 928 includes application processing circuitry 932 coupled with protocol processing circuitry 934 of the modem platform 930. The modem platform may further include digital baseband circuitry 936, transmit circuitry 938, receive circuitry 940, RF circuitry 942, RFFE circuitry 944, and antenna panels 946. The components of the AN 904 may be similar to and substantially interchangeable with like-named components of the UE 902. In addition to performing data transmission/reception as described above, the components of the AN 908 may perform various logical functions that include, for example, RNC functions such as radio bearer management, UL and DL dynamic radio resource management, and data packet scheduling.

Examples of the antenna elements of the antenna panels 926 and/or the antenna elements of the antenna panels 946 include planar inverted-F antennas (PIFAs), monopole antennas, dipole antennas, loop antennas, patch antennas, Yagi antennas, parabolic dish antennas, omni-directional antennas, and/or the like.

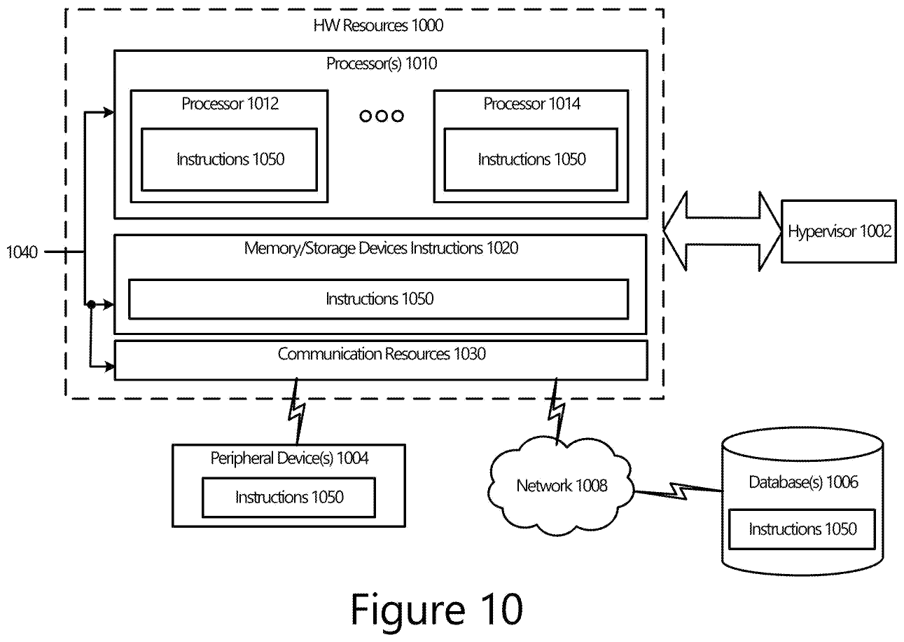

FIG. 10 illustrates components capable of reading instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040 or other interface circuitry. For examples where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014. The processors 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1020 may include main memory, disk storage, or any suitable combination thereof. The memory/storage devices 1020 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface controllers, components, or other suitable devices to communicate with one or more peripheral devices 1004 or one or more databases 1006 or other network elements via a network 1008. For example, the communication resources 1030 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

### 3. Example Implementations

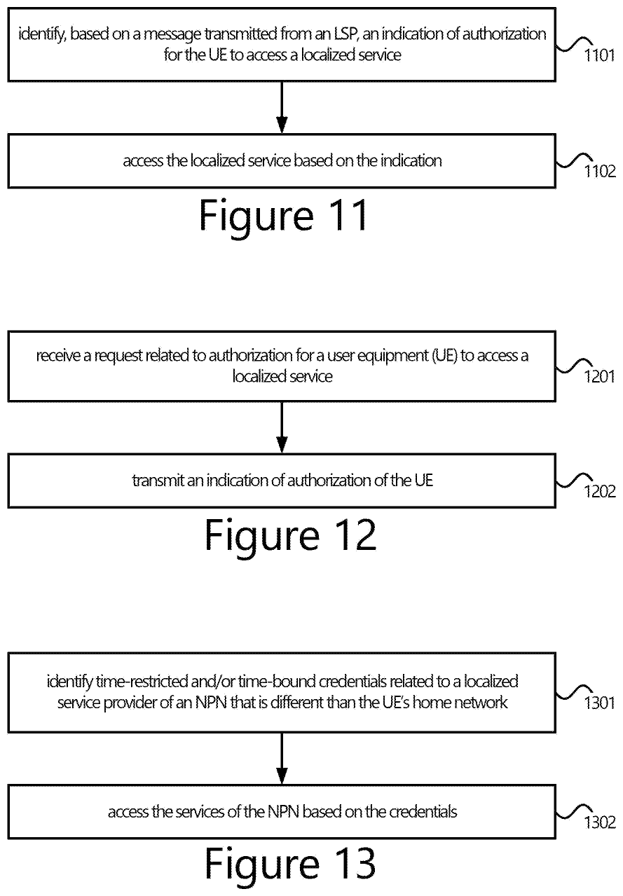

FIG. 11 shows an example process to be performed by a UE 802. The process of FIG. 11 includes identifying an indication of authorization for the UE 802 to access a localized service based on a message transmitted from an LSP 150 (1101); and accessing the localized service 155 based on the indication (1102).

FIG. 12 shows an example process to be performed by an LSP 150. The process of FIG. 12 includes receiving a request related to authorization for a UE 802 to access a localized service 155 (1201); and transmitting an indication of authorization of the UE 802 (1202).

FIG. 13 shows another example process to be performed by a UE 802. The process of FIG. 13 includes identifying time-restricted and/or time-bound credentials related to a localized service provider of an NPN that is different than the UE's 802 home network 120 (1301); and accessing the services of the NPN based on the credentials (1302).

Additional examples of the presently described methods, devices, systems, and networks discussed herein include the following, non-limiting example implementations. Each of the following non-limiting examples may stand on its own or may be combined in any permutation or combination with any one or more of the other examples provided below or throughout the present disclosure.

Example 1 includes a method for Authentication and Authorization for Localized Services.

Example 2 includes the method of example 1 and/or some other example(s) herein, wherein in which the Localized Service Provider (LSP) acts AKMA Application Function (AF).

Example 3 includes the method of examples 1-2 and/or some other example(s) herein, wherein in which the LSP Server Middleware plays the role of IoT Server Middleware described in clause 3 of [GSMAIoT.04].

Example 4 includes the method of example 2 and/or some other example(s) herein, wherein in which K_{AKMA} key is used as anchor key to generate KLSP-PSK for mutual authentication between the UE and the Hosting Network where the LSP acts Credentials Holder.

Example 5 may include method of example 3 and/or some other example(s) herein, wherein in which client certificate and security profile is downloaded to UE from LSP.

Example 6 includes the method of example 5 and/or some other example(s) herein, wherein in which a security profile is used to enable mutual authentication between the UE and the Hosting network in order to provide the UE with access to localized services.

Example 7 includes a method to be performed by a user equipment (UE), one or more elements of a UE, or an electronic device that includes and/or implements a UE, wherein the method comprises: identifying, based on a message transmitted from a localized service provider (LSP) an indication of authorization for the UE to access a localized service; and accessing, by the UE based on the indication, the localized service.

Example 8 includes the method of example 7 and/or some other example(s) herein, wherein the indication is related to a function of an AKMA AF.

Example 9 includes the method of any of examples 7-8 and/or some other example(s) herein, wherein the LSP is to function at least partially as an AKMA AF.

Example 10 includes the method of any of examples 7-9 and/or some other example(s) herein, wherein then authorization is related to an AKMA key.

Example 11 includes the method of examples 7-10 and/or some other example(s) herein, wherein the indication is related to authorization by an IoT server middleware.

Example 12 includes the method of any of examples 7 or 11 and/or some other example(s) herein, wherein the LSP is to function at least partially as the IoT server middleware.

Example 13 includes a method to be performed by a localized service provider (LSP), one or more elements of an LSP, and/or an electronic device that implements or includes an LSP, wherein the method comprises: receiving a request related to authorization for a user equipment (UE) to access a localized service; and transmitting an indication of authorization of the UE.

Example 14 includes the method of example 13 and/or some other example(s) herein, wherein the indication is related to a function of an AKMA AF.

Example 15 includes the method of any of examples 13-14 and/or some other example(s) herein, wherein the LSP is to function at least partially as an AKMA AF.

Example 16 includes the method of any of examples 13-15 and/or some other example herein, wherein then authorization is related to an AKMA key.

Example 17 includes the method of examples 13-16 and/or some other example(s) herein, wherein the indication is related to authorization by an IoT server middleware.

Example 18 includes the method of any of examples 13 or 17 and/or some other example(s) herein, wherein the LSP is to function at least partially as the IoT server middleware.

Example 19 includes a method in which time-restricted/bound credentials are used to access localized services by a UE.

Example 20 includes the method of example 19 and/or some other example(s) herein, where the Home Network obtains time-restricted credentials from the localized service provider providing service.

Example 21 includes the method of example 20 and/or some other example(s) herein, where the time-restricted credentials include, e.g., SNPN ID and geographical coordinates of the Hosting Network, user id and security credential for access to the Home Network, user id and security credential for access to the LSP server providing the localized service, DNN/S-NSSAI for the establishment of a PDU Session in the Hosting Network with optional credentials for secondary authentication.

Example 22 includes the method of example 21 and/or some other example(s) herein, wherein in which UE connects to the Hosting Network and is authenticated by the LSP in the role of Credential Holder (e.g., using an authentication, authorization, and accounting (AAA) server) based on the user id and security credential for access to the home network.

Example 23 includes a method to be performed by a user equipment (UE) in a cellular network, one or more elements of a UE, and/or an electronic device that includes a UE, wherein the method comprises: identifying time-restricted and/or time-bound credentials related to a localized service provider of a non-public network (NPN) that is different than the UE's 802 home network; and accessing, based on the credentials, the services of the NPN.

Example 24 includes the method of example 23 and/or some other example(s) herein, wherein the credentials are provided by the UE's 802 home network.

Example 25 includes the method of any of examples 23-24 and/or some other example(s) herein, wherein the credentials include one or more of and SNPN ID of the NPN, geographical coordinates of the Hosting Network, user id and security credential for access to the Home Network, user id and security credential for access to the LSP server providing the localized service, and/or DNN/S-NSSAI for the establishment of a PDU Session in the Hosting Network with optional credentials for secondary authentication.

Example Z01 may include an apparatus comprising means to perform one or more elements of a method described in or related to any of examples 1-25, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Example Z03 may include an apparatus comprising logic, modules, or circuitry to perform one or more elements of a method described in or related to any of examples 1-25, or any other method or process described herein.

Example Z04 may include a method, technique, or process as described in or related to any of examples 1-25, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-25, or portions thereof.

Example Z06 may include a signal as described in or related to any of examples 1-25, or portions or parts thereof.

Example Z07 may include a datagram, packet, frame, segment, protocol data unit (PDU), or message as described in or related to any of examples 1-25, or portions or parts thereof, or otherwise described in the present disclosure.

Example Z08 may include a signal encoded with data as described in or related to any of examples 1-25, or portions or parts thereof, or otherwise described in the present disclosure.

Example Z09 may include a signal encoded with a datagram, packet, frame, segment, protocol data unit (PDU), or message as described in or related to any of examples 1-25, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Example Z11 may include a computer program comprising instructions, wherein execution of the program by a processing element is to cause the processing element to carry out the method, techniques, or process as described in or related to any of examples 1-25, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 4. Terminology

For the purposes of the present document, the following terms and definitions are applicable to the examples and embodiments discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, engines, components, and so forth, or combinations thereof. The term “entity” at least in some examples refers to a distinct element of a component, architecture, platform, device, and/or system. Additionally or alternatively, the term “entity” at least in some examples refers to information transferred as a payload.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing. The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some examples, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g., software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to technical control and logging mechanisms to enforce or reconcile policy rules (information use rules) and to ensure accountability in information systems. The term “gateway” at least in some examples refers to a network appliance that allows data to flow from one network to another network, or a computing system or application configured to perform such tasks. Examples of gateways include IP gateways, Internet-to-Orbit (I2O) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” includes any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM″ at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface. The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA. The term “primary cell” or “PCell” at least in some examples refers to a Master Cell Group (MCG) cell, operating on a primary frequency, in which a UE either performs an initial connection establishment procedure or initiates a connection re-establishment procedure. The term “Secondary Cell” or “SCell” at least in some examples refers to a cell providing additional radio resources on top of a special cell (SpCell) for a UE configured with CA. The term “special cell” or “SpCell” at least in some examples refers to a PCell for non-DC operation or refers to a PCell of an MCG or a PSCell of an SCG for DC operation. The term “Master Cell Group” or “MCG” at least in some examples refers to a group of serving cells associated with a “Master Node” comprising a SpCell (PCell) and optionally one or more SCells. The term “Secondary Cell Group” or “SCG” at least in some examples refers to a subset of serving cells comprising a Primary SCell (PSCell) and zero or more SCells for a UE configured with DC. The term “Primary SCG Cell” refers to the SCG cell in which a UE performs random access when performing a reconfiguration with sync procedure for DC operation. The term “handover” at least in some examples refers to the transfer of a user's connection from one radio channel to another (can be the same or different cell). Additionally or alternatively, the term “handover” at least in some examples refers to the process in which a radio access network changes the radio transmitters, radio access mode, and/or radio system used to provide the bearer services, while maintaining a defined bearer service QoS.

The term “Master Node” or “MN” at least in some examples refers to a NAN that provides control plane connection to a core network. The term “Secondary Node” or “SN” at least in some examples refers to a NAN providing resources to the UE in addition to the resources provided by an MN and/or a NAN with no control plane connection to a core network. The term “E-UTEAN NodeB”, “eNodeB”, or “eNB” at least in some examples refers to a RAN node providing E-UTRA user plane (e.g., PDCP, RLC, MAC, PHY) and control plane (e.g., RRC) protocol terminations towards a UE, and connected via an S1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (Apr. 15, 2022) (“[TS37340]”)). Two or more en-gNBs are interconnected with each other (and/or with one or more eNBs) by means of an X2 interface.

The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point” or “TRxP” at least in some examples refers to an antenna array with one or more antenna elements available to a network located at a specific geographical location for a specific area. The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which an CU, DU, and/or RU are physically separated from one another. Additionally or alternatively, the term “split architecture” at least in some examples refers to a RAN architecture such as those discussed in 3GPP TS 38.401 v17.4.0 (Apr. 3, 2023) (“[TS38401]”), 3GPP TS 38.410 v 17.1.0 (Jun. 23, 2022), and 3GPP TS 38.473 v17.4.1 (Apr. 5, 2023) (“[TS38473]”) the contents of each of which are hereby incorporated by reference in their entireties. The term “integrated architecture at least in some examples refers to an architecture in which an RU and DU are implemented on one platform, and/or an architecture in which a DU and a CU are implemented on one platform.

The term “Residential Gateway” or “RG” at least in some examples refers to a device providing, for example, voice, data, broadcast video, video on demand, to other devices in customer premises. The term “Wireline 5G Access Network” or “W-5GAN” at least in some examples refers to a wireline AN that connects to a 5GC via N2 and N3 reference points. The W-5GAN can be either a W-5GBAN or W-5GCAN. The term “Wireline 5G Cable Access Network” or “W-5GCAN” at least in some examples refers to an Access Network defined in/by CableLabs. The term “Wireline BBF Access Network” or “W-5GBAN” at least in some examples refers to an Access Network defined in/by the Broadband Forum (BBF). The term “Wireline Access Gateway Function” or “W-AGF” at least in some examples refers to a Network function in W-5GAN that provides connectivity to a 3GPP 5G Core network (5GC) to 5G-RG and/or FN-RG. The term “5G-RG” at least in some examples refers to an RG capable of connecting to a 5GC playing the role of a user equipment with regard to the 5GC; it supports secure element and exchanges N1 signaling with 5GC. The 5G-RG can be either a 5G-BRG or 5G-CRG.

The term “SMTC” refers to an SSB-based measurement timing configuration configured by SSB-MeasurementTimingConfiguration. The term “SSB” refers to an SS/PBCH block.

The term “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “edge computing” at least in some examples refers to an implementation or arrangement of distributed computing elements that move processing activities and resources (e.g., compute, storage, acceleration, and/or network resources) towards the “edge” of the network in an effort to reduce latency and increase throughput for endpoint users (client devices, user equipment, and the like). Additionally or alternatively, term “edge computing” at least in some examples refers to a set of services hosted relatively close to a client/UE's access point of attachment to a network to achieve relatively efficient service delivery through reduced end-to-end latency and/or load on the transport network. In some examples, edge computing implementations involve the offering of services and/or resources in a cloud-like systems, functions, applications, and subsystems, from one or multiple locations accessible via wireless networks. Additionally or alternatively, term “edge computing” at least in some examples refers to the concept, as described in [TS23501], that enables operator and 3rd party services to be hosted close to a UE's access point of attachment, to achieve an efficient service delivery through the reduced end-to-end latency and load on the transport network. The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. however, references to an “edge computing system” generally refer to a distributed architecture, organization, or collection of multiple nodes and devices, and which is organized to accomplish or offer some aspect of services or resources in an edge computing setting. The term “edge computing platform” or “edge platform” at least in some examples refers to a collection of functionality that is used to instantiate, execute, or run edge applications on a specific edge compute node (e.g., virtualization infrastructure and/or the like), enable such edge applications to provide and/or consume edge services, and/or otherwise provide one or more edge services. The term “edge application” or “edge app” at least in some examples refers to an application that can be instantiated on, or executed by, an edge compute node within an edge computing network, system, or framework, and can potentially provide and/or consume edge computing services. The term “edge service” at least in some examples refers to a service provided via an edge compute node and/or edge platform, either by the edge platform itself and/or by an edge application.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “network function” or “NF” at least in some examples refers to a functional block within a network infrastructure that has one or more external interfaces and a defined functional behavior. The term “network instance” at least in some examples refers to information identifying a domain; in some examples, a network instance is used by a UPF for traffic detection and routing. The term “network service” or “NS” at least in some examples refers to a composition or collection of NF(s) and/or network service(s), defined by its functional and behavioral specification(s). The term “NF service instance” at least in some examples refers to an identifiable instance of the NF service. The term “NF instance” at least in some examples refers to an identifiable instance of an NF. The term “NF service” at least in some examples refers to functionality exposed by an NF through a service-based interface and consumed by other authorized NFs.

The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “management function” at least in some examples refers to a logical entity playing the roles of a service consumer and/or a service producer. The term “management service” at least in some examples refers to a set of offered management capabilities. The term “network function virtualization” or “NFV” at least in some examples refers to the principle of separating network functions from the hardware they run on by using virtualization techniques and/or virtualization technologies. The term “virtualized network function” or “VNF” at least in some examples refers to an implementation of an NF that can be deployed on a Network Function Virtualization Infrastructure (NFVI). The term “Network Functions Virtualization Infrastructure Manager” or “NFVI” at least in some examples refers to a totality of all hardware and software components that build up the environment in which VNFs are deployed. The term “Virtualized Infrastructure Manager” or “VIM” at least in some examples refers to a functional block that is responsible for controlling and managing the NFVI compute, storage and network resources, usually within one operator's infrastructure domain. The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings. The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “non-public network” or “NPN” at least in some examples refers to a network that is intended for non-public use. Additionally or alternatively, the term “non-public network” or “NPN” at least in some examples refers to a fifth generation system (5GS) deployed for non-public use (see e.g., 3GPP TS 22.261 v19.2.0 (Mar. 31, 2023) (“[TS22261]”)). In some examples, an NPN is either a stand-alone NPN (SNPN) or a public network integrated NPN (PNI-NPN). The term “stand-alone non-public network” or “SNPN” at least in some examples refers to an NPN operated by an NPN operator and not relying on network functions provided by a PLMN. The term “public network integrated non-public network” or “PNI-NPN” at least in some examples refers to a non-public network deployed with the support of a PLMN.

The term “local service” or “localized service” at least in some examples refers to a service, which is localized (e.g., provided at specific/limited area) and/or can be bounded in time. In some examples, a localized service can be realized via applications (e.g., live or on-demand audio/video stream, electric game, IMS, and/or the like), or connectivity (e.g., UE to UE, UE to Data Network, and/or the like).

The term “localized service provider” at least in some examples refers to an application provider or network operator who make their services localized and to be offered to end user via a hosting network.

The term “hosting network” at least in some examples refers to a network providing access to Local/Localized services.

The term “hosted service” or “hosting service” at least in some examples refers to a service containing the operator's own application(s) and/or trusted third-party application(s) in the service hosting environment, which can be accessed by the user. The term “service hosting environment” at least in some examples refers to the environment, located inside of a 5G network and fully controlled by the operator, where hosted services are offered from.

The term “home network” at least in some examples refers to a network owning the current in-use subscription/credential of a UE. In some examples, a home network is either PLMN or NPN. In some SNPN-related examples, UE access using credentials owned by a credentials holder separate from the SNPN.

The term “home network service” at least in some examples refers to a service, which is offered to a UE based on subscription agreed with a home network operator.

The term “return to home network” at least in some examples refers to when a UE leaves a hosting network (e.g., when the local/localized service is terminated), and resumes to use subscription/credential(s) of a home network. In some examples, a return to home network can involve a network selection (e.g., selecting HPLMN or VPLMN) and can involve deactivation/activation of SNPN access mode.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and includes identifying communication partners, determining resource availability, and synchronizing communication. Examples of application layer protocols include HTTP, HTTPS, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signalling Radio Bearers (SRBs) and Data Radio Bearers (DRBs); mobility functions/services; QoS management; and some sidelink specific services and functions over the Uu interface (see e.g., 3GPP TS 36.331 v17.4.0 (Mar. 30, 2023) (“[TS36331]”) and/or 3GPP TS 38.331 v17.4.0 (Mar. 30, 2023) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (Apr. 13, 2022) (“[TS37324]”).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.2.0 (Jan. 13, 2023) and/or 3GPP TS 38.323 v17.4.0 (Mar. 28, 2023) (“[TS38323]”)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 36.322 v17.0.0 (Apr. 15, 2022) and 3GPP TS 38.322 v17.2.0 (Jan. 13, 2023) (“[TS38322]”)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., 3GPP TS 36.321 v17.3.0 (Jan. 13, 2023), and 3GPP TS 38.321 v17.4.0 (Mar. 29, 2023) (“[TS38321]”).

The term “physical layer”, “PHY layer”, or “PHY” at least in some examples refers to a protocol layer or sublayer that includes capabilities to transmit and receive modulated signals for communicating in a communications network (see e.g., 3GPP TS 36.201 v17.0.0 (Mar. 31, 2022), and 3GPP TS 38.201 v17.0.0 (Jan. 5, 2022) (“[TS38201]”)

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include wireless access technologies/RATs, wireline, wireline-cable, wireline broadband forum (wireline-BBF), Ethernet (see e.g., IEEE Standard for Ethernet, IEEE Std 802.3-2018 (31 Aug. 2018) (“[IEEE8023]”)) and variants thereof, fiber optics networks (e.g., ITU-T G.651, ITU-T G.652, Optical Transport Network (OTN), Synchronous optical networking (SONET) and synchronous digital hierarchy (SDH), and the like), digital subscriber line (DSL) and variants thereof, Data Over Cable Service Interface Specification (DOCSIS) technologies, hybrid fiber-coaxial (HFC) technologies, and/or the like. Examples of RATs (or RAT types) and/or communications protocols include Advanced Mobile Phone System (AMPS) technologies (e.g., Digital AMPS (D-AMPS), Total Access Communication System (TACS) and variants thereof, such as Extended TACS (ETACS), and the like); Global System for Mobile Communications (GSM) technologies (e.g., Circuit Switched Data (CSD), High-Speed CSD (HSCSD), General Packet Radio Service (GPRS), and Enhanced Data Rates for GSM Evolution (EDGE)); Third Generation Partnership Project (3GPP) technologies (e.g., Universal Mobile Telecommunications System (UMTS) and variants thereof (e.g., UMTS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) and variants thereof (e.g., HSPA Plus (HSPA+)), Long Term Evolution (LTE) and variants thereof (e.g., LTE-Advanced (LTE-A), Evolved UTRA (E-UTRA), LTE Extra, LTE-A Pro, LTE LAA, MuLTEfire, and the like), Fifth Generation (5G) or New Radio (NR), narrowband IoT (NB-IOT), 3GPP Proximity Services (ProSe), and/or the like); ETSI RATs (e.g., High Performance Radio Metropolitan Area Network (HiperMAN), Intelligent Transport Systems (ITS) (e.g., ITS-G5, ITS-G5B, ITS-G5C, and the like), and the like); Institute of Electrical and Electronics Engineers (IEEE) technologies and/or WiFi (e.g., IEEE Standard for Local and Metropolitan Area Networks: Overview and Architecture, IEEE Std 802-2014, pp. 1-74 (30 Jun. 2014) (“[IEEE802]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), IEEE 802.15 technologies (e.g., IEEE Standard for Low-Rate Wireless Networks, IEEE Std 802.15.4-2020, pp. 1-800 (23 Jul. 2020) (“[IEEE802154]”) and variants thereof (e.g., ZigBee, WirelessHART, MiWi, ISA100.11a, Thread, IPv6 over Low power WPAN (6LoWPAN), and the like), IEEE Standard for Local and metropolitan area networks—Part 15.6: Wireless Body Area Networks, IEEE Std 802.15.6-2012, pp. 1-271 (29 Feb. 2012), and the like), WLAN V2X RATs (e.g., IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”) (which is now part of [IEEE80211]), IEEE Guide for Wireless Access in Vehicular Environments (WAVE) Architecture, IEEE STANDARDS ASSOCIATION, IEEE 1609.0-2019 (10 Apr. 2019) (“[IEEE16090]”), IEEE 802.11bd, Dedicated Short Range Communications (DSRC), and/or the like), Worldwide Interoperability for Microwave Access (WiMAX) (e.g., IEEE Standard for Air Interface for Broadband Wireless Access Systems, IEEE Std 802.16-2017, pp. 1-2726 (2 Mar. 2018) (“[WiMAX]”)), Mobile Broadband Wireless Access (MBWA)/iBurst (e.g., IEEE 802.20 and variants thereof), Wireless Gigabit Alliance (WiGig) standards (e.g., IEEE 802.11ad, IEEE 802.11ay, and the like), and so forth); Integrated Digital Enhanced Network (iDEN) and variants thereof (e.g., Wideband Integrated Digital Enhanced Network (WiDEN)); millimeter wave (mmWave) technologies/standards (e.g., wireless systems operating at 10-300 GHz and above 3GPP 5G); short-range and/or wireless personal area network (WPAN) technologies/standards (e.g., IEEE 802.15 technologies (e.g., as mentioned previously); Bluetooth and variants thereof (e.g., Bluetooth 5.3, Bluetooth Low Energy (BLE), and the like), WiFi-direct, Miracast, ANT/ANT+, Z-Wave, Universal Plug and Play (UPnP), low power Wide Area Networks (LPWANs), Long Range Wide Area Network (LoRA or LoRaWAN™), and the like); optical and/or visible light communication (VLC) technologies/standards (e.g., IEEE Standard for Local and metropolitan area networks—Part 15.7: Short-Range Optical Wireless Communications, IEEE Std 802.15.7-2018, pp. 1-407 (23 Apr. 2019), and the like); Sigfox; Mobitex; 3GPP2 technologies (e.g., cdmaOne (2G), Code Division Multiple Access 2000 (CDMA 2000), and Evolution-Data Optimized or Evolution-Data Only (EV-DO); Push-to-talk (PTT), Mobile Telephone System (MTS) and variants thereof (e.g., Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) and variants thereof (e.g., DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “carrier” at least in some examples refers to a modulated waveform conveying one or more physical channels (e.g., 5G/NR, E-UTRA, UTRA, and/or GSM/EDGE physical channels). The term “carrier frequency” at least in some examples refers to the center frequency of a cell.

The term “bearer” at least in some examples refers to an information transmission path of defined capacity, delay, bit error rate, and/or the like. The term “radio bearer” at least in some examples refers to the service provided by Layer 2 (L2) for transfer of user data between user equipment (UE) and a radio access network (RAN). The term “radio access bearer” at least in some examples refers to the service that the access stratum provides to the non-access stratum for transfer of user data between a UE and a CN.

The term “subframe” at least in some examples at least in some examples refers to a time interval during which a signal is signaled. In some implementations, a subframe is equal to 1 millisecond (ms). The term “time slot” at least in some examples at least in some examples refers to an integer multiple of consecutive subframes. The term “superframe” at least in some examples at least in some examples refers to a time interval comprising two time slots.

The term “channel coding” at least in some examples refers to processes and/or techniques to add redundancy to messages or packets in order to make those messages or packets more robust against noise, channel interference, limited channel bandwidth, and/or other errors. For purposes of the present disclosure, the term “channel coding” can be used interchangeably with the terms “forward error correction” or “FEC”; “error correction coding”, “error correction code”, or “ECC”; and/or “network coding” or “NC”. The term “network coding” at least in some examples refers to processes and/or techniques in which transmitted data is encoded and decoded to improve network performance. The term “code rate” at least in some examples refers to the proportion of a data stream or flow that is useful or non-redundant (e.g., for a code rate of k/n, for every k bits of useful information, the (en)coder generates a total of n bits of data, of which n-k are redundant). The term “systematic code” at least in some examples refers to any error correction code in which the input data is embedded in the encoded output. The term “non-systematic code” at least in some examples refers to any error correction code in which the input data is not embedded in the encoded output. The term “interleaving” at least in some examples refers to a process to rearrange code symbols so as to spread bursts of errors over multiple codewords that can be corrected by ECCs. The term “code word” or “codeword” at least in some examples refers to an element of a code or protocol, which is assembled in accordance with specific rules of the code or protocol.

The term “network address” at least in some examples refers to an identifier for a node or host in a computer network, and may be a unique identifier across a network and/or may be unique to a locally administered portion of the network. Examples of identifiers and/or network addresses can include am application identifier, Bluetooth hardware device address (BD_ADDR), a cellular network address (e.g., Access Point Name (APN), AMF name and/or AMF identifier (ID), AF-Service-Identifier, Closed Access Group Identifier (CAG-ID), Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, gNB Identifier (gNB ID), Global gNB ID, International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Local NG-RAN Node Identifier, Mobile Subscriber Identification Number (MSIN), Mobile Subscriber/Station ISDN Number (MSISDN), Network identifier (NID), NR Cell Global Identifier (NCGI), Network Slice Instance (NSI) ID, Network Slice AS Group (NSAG), Permanent Equipment Identifier (PEI), Public Land Mobile Network (PLMN) ID, Physical Cell Identifier (PCI), QoS Flow ID (QFI) and/or 5G QoS Identifier (5QI), RAN ID, Routing Indicator, Radio Network Temporary Identifier (RNTI) and variants thereof (e.g., any of those discussed in clause 8 of 3GPP TS 38.300 v17.4.0 (Mar. 28, 2023) (“[TS38300]”) and/or NCR-RNTI discussed previously), SMS Function (SMSF) ID, Stand-alone Non-Public Network (SNPN) ID, Single Network Slice Selection Assistance information (S-NSSAI), sidelink identities (e.g., Source Layer-2 ID, Destination Layer-2 ID, PC5 Link Identifier, and the like), Subscription Concealed Identifier (SUCI), Subscription Permanent Identifier (SUPI), Temporary Mobile Subscriber Identity (TMSI) and variants thereof, Tracking Area identity (TAI), UE Access Category and Identity, and/or other cellular network related identifiers), CAG-ID, drivers license number, Global Trade Item Number (GTIN) (e.g., Australian Product Number (APN), EPC, European Article Number (EAN), Universal Product Code (UPC), and the like), email address, Enterprise Application Server (EAS) ID, an endpoint address, an Electronic Product Code (EPC) as defined by the EPCglobal Tag Data Standard, Fully Qualified Domain Name (FQDN), flow ID and/or flow hash, hash value, index, internet protocol (IP) address in an IP network (e.g., IP version 4 (IPv4), IP version 6 (IPv6), and the like), an internet packet exchange (IPX) address, LAN ID, a MAC address, personal area network (PAN) ID, port number (e.g., TCP port number, UDP port number, and the like), price lookup code (PLC), product key, QUIC connection ID, RFID tag, sequence number, service set identifier (SSID) and variants thereof, screen name, serial number, stock keeping unit (SKU), socket address, social security number (SSN), telephone number (e.g., in a public switched telephone network (PTSN)), unique identifier (UID) (e.g., including globally UID, universally unique identifier (UUID) (e.g., as specified in ISO/IEC 11578:1996), and the like), a Universal Resource Locator (URL) and/or Universal Resource Identifier (URI), user name (e.g., ID for logging into a service provider platform, such as a social network and/or some other service), vehicle identification number (VIN), Virtual LAN (VLAN) ID, X.21 address, an X.25 address, Zigbee® ID, Zigbee® Device Network ID, and/or any other suitable network address and components thereof.

The term “endpoint address” at least in some examples refers to an address used to determine the host/authority part of a target network address (e.g., URI and/or any other network address(es), such as those discussed herein), where the target network address (e.g., URI and/or any other network address(es), such as those discussed herein) is used to access an NF service (e.g., to invoke service operations) of an NF service producer or for notifications to an NF service consumer. The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service. Additionally or alternatively, the term “port” at least in some examples refers to a particular interface of the specified equipment (apparatus) with an electromagnetic environment (e.g., any connection point on an equipment intended for connection of cables to or from that equipment is considered as a port).

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment. The term “process” at least in some examples refers to an instance of a computer program that is being executed by one or more threads. In some implementations, a process may be made up of multiple threads of execution that execute instructions concurrently. The term “algorithm” at least in some examples refers to an unambiguous specification of how to solve a problem or a class of problems by performing calculations, input/output operations, data processing, automated reasoning tasks, and/or the like.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The terms “instantiate,” “instantiation,” and the like at least in some examples refers to the creation of an instance. In some examples, the term “instance” refers to a concrete occurrence of an object, which may occur, for example, during execution of program code.

The term “reference point” at least in some examples refers to a conceptual point at the conjunction of two non-overlapping functional groups, elements, or entities. The term “service based interface” at least in some examples refers to a representation how a set of services is provided and/or exposed by a particular NF.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some examples refers to an abstract representation of any entity issuing commands, requests, and/or data to a compute node or system, and/or otherwise consumes or uses services. Additionally or alternatively, the term “user” at least in some examples refers to an entity, not part of the 3GPP System, which uses 3GPP System services (e.g., a person using a 3GPP system mobile station as a portable telephone). The term “user profile” at least in some examples refers to a set of information to provide a user with a consistent, personalized service environment, irrespective of the user's location or the terminal used (within the limitations of the terminal and the serving network).

The term “Quality of Service” or “QoS’ at least in some examples refers to a description or measurement of the overall performance of a service (e.g., telephony and/or cellular service, network service, wireless communication/connectivity service, cloud computing service, and the like). In some cases, the QoS may be described or measured from the perspective of the users of that service, and as such, QoS may be the collective effect of service performance that determine the degree of satisfaction of a user of that service. In other cases, QoS at least in some examples refers to traffic prioritization and resource reservation control mechanisms rather than the achieved perception of service quality. In these cases, QoS is the ability to provide different priorities to different applications, users, or flows, or to guarantee a certain level of performance to a flow. In either case, QoS is characterized by the combined aspects of performance factors applicable to one or more services such as, for example, service operability performance, service accessibility performance; service retain ability performance; service reliability performance, service integrity performance, and other factors specific to each service. Several related aspects of the service may be considered when quantifying the QoS, including packet loss rates, bit rates, throughput, transmission delay, availability, reliability, jitter, signal strength and/or quality measurements, and/or other measurements such as those discussed herein. Additionally or alternatively, the term “Quality of Service” or “QoS’ at least in some examples refers to mechanisms that provide traffic-forwarding treatment based on flow-specific traffic classification. In some examples, Additionally or alternatively, the term “Quality of Service” or “QoS' at least in some examples is based on the definitions provided by SERIES E: OVERALL NETWORK OPERATION, TELEPHONE SERVICE, SERVICE OPERATION AND HUMAN FACTORS Quality of telecommunication services: concepts, models, objectives and dependability planning—Terms and definitions related to the quality of telecommunication services, Definitions of terms related to quality of service, ITU-T Recommendation E.800 (September/2008) (“[ITUE800]”), the contents of which is hereby incorporated by reference in its entirety.

The term “service consumer” or “consumer” at least in some examples refers to an entity that consumes one or more services. The term “service producer” or “producer” at least in some examples refers to an entity that offers, serves, or otherwise provides one or more services. The term “service provider” or “provider” at least in some examples refers to an organization or entity that provides one or more services to at least one service consumer. For purposes of the present disclosure, the terms “service provider” and “service producer” may be used interchangeably even though these terms may refer to difference concepts. Examples of service providers include cloud service provider (CSP), network service provider (NSP), application service provider (ASP) (e.g., Application software service provider in a service-oriented architecture (ASSP)), internet service provider (ISP), telecommunications service provider (TSP), online service provider (OSP), payment service provider (PSP), managed service provider (MSP), storage service providers (SSPs), SAML service provider, and/or the like.

The term “service level agreement” or “SLA” at least in some examples refers to a level of service expected from a service provider. At least in some examples, an SLA may represent an entire agreement between a service provider and a service consumer that specifies one or more services is to be provided, how the one or more services are to be provided or otherwise supported, times, locations, costs, performance, priorities for different traffic classes and/or QoS classes (e.g., highest priority for first responders, lower priorities for non-critical data flows, and the like), and responsibilities of the parties involved. The term “service level objective” or “SLO” at least in some examples refers to one or more measurable characteristics, metrics, or other aspects of an SLA such as, for example, availability, throughput, frequency, response time, latency, QoS, QoE, and/or other like performance metrics/measurements. At least in some examples, a set of SLOs may define an expected service (or an service level expectation (SLE)) between the service provider and the service consumer and may vary depending on the service's urgency, resources, and/or budget. The term “service level indicator” or “SLI” at least in some examples refers to a measure of a service level provided by a service provider to a service consumer. At least in some examples, SLIs form the basis of SLOs, which in turn, form the basis of SLAs. Examples of SLIs include latency (including end-to-end latency), throughout, availability, error rate, durability, correctness, and/or other like performance metrics/measurements. At least in some examples, term “service level indicator” or “SLI” can be referred to as “SLA metrics” or the like. The term “service level expectation” or “SLE” at least in some examples refers to an unmeasurable service-related request, but may still be explicitly or implicitly provided in an SLA even if there is little or no way of determining whether the SLE is being met. At least in some examples, an SLO may include a set of SLIs that produce, define, or specify an SLO achievement value. As an example, an availability SLO may depend on multiple components, each of which may have a QoS availability measurement. The combination of QoS measures into an SLO achievement value may depend on the nature and/or architecture of the service.

The terms “configuration”, “policy”, “ruleset”, and/or “operational parameters”, at least in some examples refer to a machine-readable information object that contains instructions, conditions, parameters, criteria, data, metadata, and/or other information that is/are relevant to a component, device, system, network, service producer, service consumer, and/or other element/entity.

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a IEEE 802 protocol/standard (e.g., [IEEE80211] or the like), Type Length Value (TLV), and/or other like data structures. The term “packet” at least in some examples refers to an information unit identified by a label at layer 3 of the OSI reference model. In some examples, a “packet” may also be referred to as a “network protocol data unit” or “NPDU”. The term “protocol data unit” at least in some examples refers to a unit of data specified in an (N)-protocol layer and includes (N)-protocol control information and possibly (N)-user data.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information. The term “field” at least in some examples refers to individual contents of an information element, or a data element that contains content. The term “data frame”, “data field”, or “DF” at least in some examples refers to a data type that contains more than one data element in a predefined order. The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some examples refers to a markup construct including a name-value pair that exists within a start tag or empty element tag. Attributes contain data related to its element and/or control the element's behavior.

The term “reference” at least in some examples refers to data useable to locate other data and may be implemented a variety of ways (e.g., a pointer, an index, a handle, a key, an identifier, a hyperlink, and/or the like).

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The term “authorization” at least in some examples refers to a prescription that a particular behavior shall not be prevented. The term “authentication” at least in some embodiments refers to a process of proving or verifying an identity. Additionally or alternatively, the term “authentication” at least in some embodiments refers to a mechanism by which a computer system checks or verifies that a user or entity is really the user or entity being claimed. Examples of the authentication and/or authorization techniques include using API keys, basic access authentication (“Basic Auth”), Open Authorization (OAuth), hash-based message authentication codes (HMAC), Kerberos protocol, OpenID, WebID, and/or other authentication and/or authorization techniques. The term “consistency check” at least in some examples refers to a test or assessment performed to determine if data has any internal conflicts, conflicts with other data, and/or whether any contradictions exist. In some examples, a “consistency check” may operate according to a “consistency model”, which at least in some examples refers to a set of operations for performing a consistency check and/or rules or policies used to determine if data is consistent (or predictable) or not. The term “integrity” at least in some examples refers to a mechanism that assures that data has not been altered in an unapproved way. Examples of cryptographic mechanisms that can be used for integrity protection include digital signatures, message authentication codes (MAC), and secure hashes. The term “verification” at least in some examples refers to a process, method, function, or any other means of establishing the correctness of information or data.

The term “certificate” or “digital certificate” at least in some examples refers to an information object (e.g., an electronic document or other data structure) used to prove the validity of a piece of data such as a public key in a public key infrastructure (PKI) system. Examples of the digital certificates include the X.509 format and/or some other suitable format, and may be signed using any suitable cryptographic mechanisms such as Elliptic Curve cryptography Digital Signature Algorithm (ECDSA) or some other suitable algorithm such as any of those discussed herein. Additionally or alternatively, the digital certificates discussed herein can include various certificates issued by the an issuer, a verification body, a notified body, certificate authority (CA) (e.g., a root CA or the like), an enrollment authority (EA), an authorization authority (AA), and/or other entity as delineated by relevant Certificate Authority Security Council (CASC) standards, Common Computing Security Standards Forum (CCSF) standards, CA/Browser Forum standards, GSMA standards, ETSI standards, GlobalPlatform standards, and/or some other suitable standard. The term “certificate revocation list” or “CRL” at least in some examples refers to a signed list indicating a set of certificates that are no longer considered valid by the certificate issuer. The term “signature” or “digital signature” at least in some examples refers to a mathematical scheme, process, or method for verifying the authenticity of a digital message or information object (e.g., an electronic document or other data structure).

The term “confidential data” at least in some examples refers to any form of information that a person or entity is obligated, by law or contract, to protect from unauthorized access, use, disclosure, modification, or destruction. Additionally or alternatively, “confidential data” at least in some examples refers to any data owned or licensed by a person or entity that is not intentionally shared with the general public or that is classified by the person or entity with a designation that precludes sharing with the general public.

The term “cryptographic mechanism” at least in some examples refers to any cryptographic protocol and/or cryptographic algorithm. Examples of cryptographic mechanisms include a cryptographic hash algorithm, such as a function in the Secure Hash Algorithm (SHA) 2 set of cryptographic hash algorithms (e.g., SHA-226, SHA-256, SHA-512, and the like), SHA 3, and so forth, or any type of keyed or unkeyed cryptographic hash function and/or any other function discussed herein; an elliptic curve cryptographic (ECC) algorithm (e.g., Elliptic Curve cryptography Key Agreement algorithm (ECKA) algorithm, Elliptic Curve cryptography Digital Signature Algorithm (ECDSA), Lenstra elliptic-curve factorization or elliptic-curve factorization method (ECM), Menezes-Qu-Vanstone (MQV) or elliptic curve MQV (ECMQV), Elliptic Curve Diffie-Hellman (ECDH) key agreement, Elliptic Curve Integrated Encryption Scheme (ECIES) or Elliptic Curve Augmented Encryption Scheme, Edwards-curve Digital Signature Algorithm (EdDSA), and/or the like); Rivest-Shamir-Adleman (RSA) cryptography; Merkle signature scheme, advanced encryption system (AES) algorithm; a triple data encryption algorithm (3DES); Quantum cryptography algorithms; and/or the like. Additionally or alternatively, the term “cryptographic protocol” at least in some examples refers to a sequence of steps precisely specifying the actions required of two or more entities to achieve specific security objectives (e.g., cryptographic protocol for key agreement). Additionally or alternatively, the term “cryptographic algorithm” at least in some examples refers to an algorithm specifying the steps followed by a single entity to achieve specific security objectives (e.g., cryptographic algorithm for symmetric key encryption). The term “public-key cryptography” or “asymmetric cryptography” at least in some examples refers to a cryptographic system that use pairs of related keys including, for example, a public key used for generating ciphertext, and a corresponding private key to decrypt the ciphertext to obtain the original message (e.g., plaintext); in some examples, these key pairs are generated with cryptographic algorithms based on one-way functions

The term “cryptographic hash function”, “hash function”, or “hash”) at least in some examples refers to a mathematical algorithm that maps data of arbitrary size (sometimes referred to as a “message”) to a bit array of a fixed size (sometimes referred to as a “hash value”, “hash”, or “message digest”). A cryptographic hash function is usually a one-way function, which is a function that is practically infeasible to invert.

The term “cryptographic key” or “key” at least in some examples refers to a piece of information, usually a string of numbers or letters that are stored in a file, which, when processed through a cryptographic algorithm can encode or decode cryptographic data. The term “symmetric-key algorithm” at least in some examples refers to a cryptographic algorithm that uses the same cryptographic key for both the encryption of plaintext and the decryption of ciphertext; the keys may be identical, or there may be a simple transformation to go between the two keys. The term “anchor key” at least in some examples refers to a cryptographic key that is used to generate other keys. In some examples, an “anchor key” is used in key management systems to create and distribute keys to users. In some examples, an “anchor key” is stored in a secure location and is not used directly to encrypt or decrypt data. Examples of anchor keys include, master keys, subkeys, and session keys.

The term “encryption” at least in some examples refers to a process of encoding information wherein the original representation of information (referred to as “plaintext”) into an alternative form (referred to as “ciphertext”). In some examples, an encryption scheme includes use of a pseudo-random encryption key generated by a cryptographic mechanism or some other algorithm to generate an encryption key, which can be used to encrypt and/or decrypt the plaintext.

The term “one-time credential” at least in some examples refers to a type of authentication that is only valid for a single use. In some examples, a one-time credential is used for two-factor authentication (2FA), which is a security measure that requires two different forms of authentication to access an account. Examples of one-time credentials include time-based one-time passwords (TOTPs) (e.g., a one-time credential generated by a time-based algorithm that is valid for a short period of time (e.g., 30 seconds or the like; in some examples, a TOTP is generated by mobile apps or hardware tokens) and out-of-band (OOB) one-time passwords (OTPs) (e.g., a one-time credential that is sent to a user's phone (via SMS message), email address, or the like; In some examples, an OOB OTP is valid for a single use and can only be used once).

The term “data breach” at least in some examples refers to a breach of security leading to the accidental or unlawful destruction, loss, alteration, unauthorized disclosure of, or access to, data (including personal, sensitive, and/or confidential data) transmitted, stored or otherwise processed.

The term “information security” or “InfoSec” at least in some examples refers to any practice, technique, and technology for protecting information by mitigating information risks and typically involves preventing or reducing the probability of unauthorized/inappropriate access to data, or the unlawful use, disclosure, disruption, deletion, corruption, modification, inspection, recording, or devaluation of information; and the information to be protected may take any form including electronic information, physical or tangible (e.g., computer-readable media storing information, paperwork, and the like), or intangible (e.g., knowledge, intellectual property assets, and the like).

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1.-37. (canceled)

38. An apparatus for use in a user equipment (UE), wherein the apparatus comprising:
memory to store a received prompt for accessing localized service by a localized service advertisement; and
one or more processors configured to:
encode, for transmission to a home network based on the prompt, a request related to access to a localized service, wherein the request is to cause the home network to obtain time-restricted credentials from a localized service provider (LSP) providing the localized service;
identify, from the home network based on the request, the time-restricted credentials;
establish a connection with a hosting network based on the time-restricted credentials; and
encode, for transmission, information related to access of the localized service of the LSP via the hosting network after authentication of the UE based on the time-restricted credentials.

38. The apparatus of claim 38, wherein the one or more processors are further configured to encode, for transmission to the home network via a connection to a web portal of a home network operator, the request related to information for access to the localized service.

39. The apparatus of claim 39, wherein the time-restricted credentials are received via the web portal.

40. The apparatus of claim 37, wherein the time-restricted credentials are received via a short message service (SMS) message.

41. The apparatus of claim 37, wherein the one or more processors are further configured to:
select the hosting network when the UE arrives at a location where the localized service is to be provided.

42. The apparatus of claim 37, wherein establishing the connection with the hosting network is to cause the LSP to authenticate the UE.

43. The apparatus of claim 37, wherein the one or more processors are further configured to encode a request for a protocol data unit (PDU) session to access the localized service.

44. The apparatus of claim 37, wherein the access to the localized service includes accessing services of the home network using an over-the-top (OTT) connection with the home network in parallel with the access to the localized service.

45. The apparatus of claim 37, wherein the one or more processors are further configured to encode a request for release of the UE when the time-restricted credentials expire.

46. The apparatus of claim 37, wherein the time-restricted credentials include one or more of: a standalone non-public network (SNPN) identifier (ID), geographical coordinates of the hosting network, a UE ID, security credentials for accessing the home network, AKMA Anchor Key (KAKMA), data network name (DNN) for establishing a PDU Session in the hosting network, single network slice selection assistance information (S-NSSAI) for establishing a PDU Session in the hosting network, credentials for secondary authentication, and a time-based one-time passwords (TOTPs).

47. One or more computer-readable media comprising instructions that, upon execution of the instructions by one or more processors of an electronic device that implements a localized service provider (LSP) server, are to cause the LSP server to:
issue a localized service advertisement to a user equipment (UE) to prompt the UE for access to a localized service provided by the LSP server;
provide a time-restricted credential to a home network for delivery to the UE based on a request by the UE to the home network for information for access to the localized service;
authenticate the UE based on the time-restricted credential in response to the UE attempting to establish a connection with a hosting network using the time-restricted credential; and
provide access to the localized service via the hosting network after the authentication of the UE based on the time-restricted credential.

48. The one or more computer-readable of claim 47, wherein the instructions are further to cause the LSP server to:
establish a service agreement with an operator of the hosting network, wherein the service agreement defines how to provide access to the localized service; and
configure the hosting network based on the service agreement.

49. The one or more computer-readable media of claim 47, wherein the LSP is in a role of credential holder to authenticate the UE.

50. The one or more computer-readable media of claim 47, wherein the LSP is in a role of an Authentication and Key Management for Applications (AKMA) application function (AF) to authenticate the UE.

51. The one or more computer-readable media of claim 50, wherein the instructions are further to cause the LSP server to:
identify an AKMA key identifier (A-KID) received from the UE in an application service request;
obtain, from an AKMA anchor function (AAnF), an AKMA Application Key (KAF) corresponding to an AKMA key (KAKMA) belonging to the UE;
derive a pre-shared key using the KAF; and
transmit, to the UE, an application service response including a counter LSP value that is to be used by the UE to derive the KAF.

52. The one or more computer-readable media of claim 51, wherein the KAF is the time-restricted credential.

53. The one or more computer-readable media of claim 51, wherein authentication of the UE includes:
performing mutual authentication of the UE and the LSP using transport layer security (TLS) based on the KAF when the UE attempts to access the localized service via the hosting network.

54. The one or more computer-readable media of claim 47, wherein the LSP server includes internet of things (IoT) server middleware, and authentication of the UE includes:
identify, received from the UE, a service provisioning request requesting a client certificate;
transmit, to an LSP security applet implemented by the UE, a subscriber identity module (SIM) applet certificate and security profile corresponding to the LSP; and
authenticate the UE based on the SIM applet certificate and the security profile when the UE attempts to access the localized service via the hosting network.

55. The one or more computer-readable media of claim 47, wherein the instructions are further to cause the LSP server to request release of the UE when expiry of the time-restricted credential expires.

56. The one or more computer-readable media of claim 47, wherein the time-restricted credential includes one or more of: a standalone non-public network (SNPN) identifier (ID), geographical coordinates of the hosting network, a UE ID, security credentials for accessing the home network, AKMA Anchor Key (KAKMA), data network name (DNN) for establishing a PDU Session in the hosting network, single network slice selection assistance information (S-NSSAI) for establishing a PDU Session in the hosting network, credentials for secondary authentication, and a time-based one-time passwords (TOTPs).
